(19) United States
(12) Patent Application Publication
(10) Pub. No.: US 2014/0331135 A1
(43) Pub. Date: Nov. 6, 2014

(54) DIGITAL CONTENT CONNECTIVITY AND CONTROL VIA A PLURALITY OF CONTROLLERS THAT ARE TREATED AS A SINGLE CONTROLLER

(71) Applicant: Sookbox LLC, Cambridge, MA (US)

(72) Inventors: David Sukoff, Bedford, MA (US); Cyrus Vafadari, Cambridge, MA (US); Mathew Peterson, Boston, MA (US); Adam Mustafa, Cambridge, MA (US)

(73) Assignee: Sookbox LLC, Cambridge, MA (US)

(21) Appl. No.: 14/147,397

(22) Filed: Jan. 3, 2014

Related U.S. Application Data
(63) Continuation-in-part of application No. 13/734,511, filed on Jan. 4, 2013.
(60) Provisional application No. 61/749,436, filed on Jan. 7, 2013.
(60) Provisional application No. 61/749,430, filed on Jan. 7, 2013.
(60) Provisional application No. 61/857,369, filed on Jul. 23, 2013.

(51) Int. Cl. H04L 29/06; G06F 3/0484

(52) U.S. Cl. CPC H04L 65/60; G06F 3/0484
USPC 715/719

(57) ABSTRACT

Managing the separation and distribution of digital content and associated controls in a network system includes receiving a request from any of a set of control devices within the same active session, to which a host server provides a response that is suitable for all control devices. The control devices handle such responses in the context of user experience-optimized application types that facilitate separating and distributing associated application type control, digital content, and/or status information during an active session from the host server to the control devices and to output devices that are connected together through the network, such as a home network.

### CROSS-REFERENCE TO RELATED APPLICATIONS

This application claims the benefit of the following provisional applications, each of which is hereby incorporated by reference in its entirety: U.S. provisional application 61/749,436, filed Jan. 7, 2013, U.S. provisional application 61/749,430, filed Jan. 7, 2013, and U.S. provisional application 61/857,369, filed Jul. 23, 2013.

This application is a continuation-in-part of U.S. patent application Ser. No. 13/734,511, filed Jan. 4, 2013, the entirety of which is incorporated herein by reference.

### BACKGROUND OF THE INVENTION

1. Field

The methods and systems described, depicted, and claimed herein may relate to managing and distributing the separation of media content and associated controls within a network system.

2. Description of the Related Art

In the modern homes of today there typically are multiple means for receiving and displaying digital content on various display devices. Also, there are various electronic devices throughout the home that are networked together in a fashion for providing the user with a means for entertainment which often include, but are not limited to, personal computers, televisions, Internet television (“smart” televisions), digital video disk (DVD) players, compact disk (CD) players, set-top boxes (STBs), audio/video receivers (AVRs), digital video recorders (DVRs), gaming devices, digital cameras, smart-phones tablets, etc. Also, networked connected devices may also be adapted to receive content from multiple inputs representing Internet Protocol (IP) input connections.

Even with all of the advancements discussed above, there still are vast limitations in user experience for many of the devices and especially when used together. For example, while browsing the Internet on digital television (either directly or indirectly through a set-top box), the user experience is typically negated by cumbersome navigation of a complicated website, either with an attached keyboard, or limited static unidirectional remote control. Typically, personal computers (PC) work better for controlling than an Internet connected television for a user to browse the web. However, the Internet connected television can surpass the user experience than that of the personal computer (PC) experience in cases where it is used for playing high-resolution video, surround sound audio, and/or displaying content in a social/entertainment settings.

Conversely/similarly, in displaying digital content on a television that is typically viewed on a personal computer (PC) is also cumbersome. Typically, typing/searching for a webpage URL on a browser window of the television display is often challenging and limited by the television's remote control with static and unidirectional buttons features rather than the easier and more commonly known utilization of a mouse and keyboard on a personal computer (PC).

Another recent trend with respect to consumer electronic devices (more specifically, mobile devices, such as smart-phones, tablets, etc.) is that they have become increasingly affordable. In addition, the consumer electronic devices increasingly include more advanced features. These features allow homeowners to enhance their home entertainment user experience for the specific implementations of which those electronic devices are designed and sold for. As consumer electronics devices continue to become more available and improved for the user, the user's desire to access various types of digital content provided by various digital content sources (providers) also continues to grow. Unfortunately, since these consumer electronic devices such as, but not limited to, smart-phones, tablets are capable of retrieving and rendering digital content from the Internet or other networks, they are more typically designed to present the content in personal manner (smaller screen) for the single device user. Larger display devices, such as, but not limited to televisions are more typically designed to present better quality formats of video, such as high definition televisions (HDTVs) for a better and shared (more than one user) user experience.

Currently, users' access to and control of digital content throughout their home is often limited to the fractional utilization of which that device is designed for application types (e.g. watching movies, listening to music, playing games, etc.) and the various associated output and control device types throughout the various zones. Additionally, in the paradigm of consumer electronics growth and affordability it has become increasingly difficult for users to easily manage (control) and stream digital content seamlessly and transparently throughout the various output devices and associated locations (zones) cognizant of growing device control needs and associated digital content implementations (use cases) for a seamless user experience.

### SUMMARY OF THE INVENTION

Embodiments of the present disclosure include methods, systems, or computer readable medium, with program codes embodied thereon, for managing and distributing the separation of media content and associated controls within a network system.

An embodiment of the disclosure comprises a host server for managing and distributing digital media content in association with a network system that may include a plurality of computing devices with varying user interface features and capabilities as described throughout this invention.

The host server may include one or more processors, a memory, and other circuitry generally included with a network-enabled host server that is connected to the Internet. The host server may also include a plurality of outputs that are suitable for delivering content to output devices, such as monitors, speakers, smart TVs, IP-enabled devices, and the like. In addition, the host server may include a client manager configured to receive requests from a control device to deliver digital content stored in the memory or provided via Internet access through the network system, from the host server. The control device can be one control device among a plurality of control devices that have access to the host server anywhere within a network system. Since there are typically more than one display device within a home network, the viewable content items, (e.g. web content windows) may be controlled and hosted through one central location (e.g. the host server) yet viewed simultaneously and controlled independently of each other throughout various display device locations (zones) that may be serviced by the home network. Distinct host servers in a commonly shared [symbol] network may be used as central nodes logically arranged between control devices in the network and output devices in the various zones while enabling access to Internet content.

The client manager may be further configured to receive, using the one or more processors, a command from any one of a plurality of control devices to serve, via a selected output, at least one item of digital content, the session state information associated with the digital content, or the session state information for the plurality of outputs of the host server. A user of one of the control devices may select the output based on at least the session state information associated with the plurality of outputs connected to the host server within a home network system. The client manager can be further configured to authorize access, using the one or more processors, by any one of the control devices to the host server in the network system when receiving any request (e.g. initialization request) from the control devices. The control device is a device that communicates via two-way communication with the host server and optionally with other control devices within the network system (e.g. transmit/receive unit (TRU) configured to communicate). The client manager can be further configured to transmit/receive requests from the control devices to applications associated with a launched session. This will allow the host server to communicate session-specific state information to control devices in the network system.

Also, the host server may be configured to broadcast, using the one or more processors, to the plurality of control devices, session state information associated with the digital content and/or status information in response to receiving the request. The client manager may communicate with a zone manager via a resource manager of the host sever. The zone manager can be configured to associate, using the one or more processors, each of the plurality of outputs with a corresponding unique identifier. The zone manager, using the one or more processors, can be further configured to change a presentation state of the item of the digital content being served via the selected output in response to receiving a command from any one of the control devices that results in a change to the session state, such as the digital content presentation state. Also, the zone manager, using the one or more processors, can be configured to change the session presentation state of one output of the plurality of outputs, via which digital content is being served, in response to receiving a command from any one of the control devices to do so.

A session/application manager of the host server may be in communication with the client manager and the resource manager. The session/application manager, using the one or more processors, can be further configured to monitor session state information of each of the plurality of outputs and the digital content, maintain the session state information associated with each of the plurality of outputs and the state of digital content accessible by the host server (e.g. in the host server memory or provided via the Internet), and provide the plurality of control devices with the session and/or digital content status information along with the unique identifier of each of the output devices. Also, the session/application manager can be further configured to simultaneously provide, using the one or more processors, session state information for a plurality of sessions to the plurality of control devices. The session/application manager may manage and communicate status of various application types and multiple active session instances thereof.

Another example embodiment of the present disclosure includes a non-transitory computer readable medium having computer readable program codes embodied therein for managing and distributing digital content media and associated controls given the application type in a network system, the computer readable program codes including instructions that, when executed by a processor, cause the processor to receive a request from any one of a plurality of control devices to deliver at least one item of digital content either stored on or provided via Internet access of a host server through the network system from the host server. Further, the code causes the processor to uniquely identify and decide to discriminate among any of a plurality of control devices and any of a plurality of output devices when a given specific application type requires the host server to do so. Further, the code causes the processor to serve at least one item of digital content and/or the session state information via the selected outputs in response to receiving a corresponding output command from any one of the control devices.

In addition, the code causes the processor to provide control devices with session state information associated with the digital content and session state information for a plurality of outputs of the host server connected to the network system in response to receiving the request. The code also causes the processor to receive a command from the any one of the control devices to serve at least one item of digital content, session state information associated with the digital content, or the session state information for the plurality of outputs of the host server via a selected output. A user of any one of the plurality of control devices may select the output based on at least the session state information associated with the plurality of outputs connected to the network system. Further, the code causes the processor to serve the at least one item of digital content or the session state information via the selected outputs in response to receiving a corresponding host server output command from any one of the control devices.

The host server(s), control devices, and output devices may be operated in various modes including heads-down use of the control devices and heads-up use of the output devices. Separation of content and control in heads-up and heads-down modes may be embodied in utilization of socket protocols for parsing, packaging, sending, and receiving messages and information. A library of functions, features, and methods is described which can be integrated into any computer-readable program. A socket protocol is selected as an exemplary protocol embodiment as it enables low-overhead, live (“open”) connections for data exchange, as compared to HTTP client-server protocol packages.

Zone switching is another capability of the content and control separation methods and systems described here that may be enabled by a socket-enabled messaging library. The socket protocol may facilitate a user using a heads-down dynamic interface on a control device (i.e. phone, tablet, etc.) to switch heads-up content to be delivered to devices in different output zones. In particular, if in an audio/video application session a client (control device) sends a request to the host server to change the current session state of the audio output devices currently playing content (e.g. to stop playing the content), zone switching may result. Upon receiving the request the host server responds by switching the output devices being played and then non-discriminately broadcasts the session status that indicates the switched output zone to the clients (control devices) that have active connections to the host server at that time without any of those control devices initiating a request for updated session status. Examples of this preferred embodiment for active sessions include 1) control device (client) initiated request to host server, 2) host server initiated broadcast (“push”) to control devices, 3) control device (client) handling response to host server broadcast, and 4) host server handling response to control device (client) request.

Another use of the host server capabilities and features described herein relates to how visual graphical interface control elements and display content are separated to facilitate simultaneous operation of heads-up and heads-down modes. This operation may be useful in a browser application. The visual graphical interface control elements have been more commonly known as chrome elements, or widgets. In the typically known “prior art” implementation of a computer with a keyboard, mouse, and monitor, since there is only one display for viewing both the control and content elements, there is no need to separate the depiction of control from the content onto separate devices as all associated devices, the user, and said peripherals (mouse/keyboard) are all within close proximity to each other. However, for the advanced control schemes that are enabled by the methods and systems described herein, a plurality of control devices (e.g. smart-phones, tablets, etc.) generally have their own processors and displays to support heads-down mode, yet may be operated independently of other output devices for viewing the content in a heads-up mode.

User experience can be optimized by taking advantage of the control device native capabilities while utilizing a proximal display device. In a preferred embodiment, the host server hosts a session application including a browser application modified to output web content to an output device for heads-up mode viewing, while withholding browser chrome control elements (or widgets) from the output device, and communicating appropriately with control devices using a socket-enabled messaging library. The modified browser application can extract information from the typical URL browser chrome elements (or widgets). Using a socket-enabled messaging library, the modified browser application session, managed by a host server, may further be adapted to respond to an appropriate control device request by providing chrome element information. In addition, a control device may receive the relevant chrome element information (e.g. via a socket message) and update its user interface (e.g. associated browser application URL search bar) to reflect the newly provided information (e.g. the URL) in a native user interface of the mobile device for use in a heads-down mode. The user of the control device can interact with this chrome information via the control device native user interface features in order to manipulate the chrome control elements (or widgets). Thus, the browser application displays web content heads-up with no control elements, while a control device on the network can present a user with an interface optimized with native controls and widgets which can be updated with messages from the browser application session on the host server.

Further, a control device may translate user manipulations of elements depicted in its heads-down user interface into representative data from which the host server executes user-intended actions within an associated active content control session. These actions may include updating the displayed content information, the chrome elements, or both. A commonly known example of this is sending a “click on this link” message from a control device to the host server, which updates the output device content view to content indicated by the link (e.g. a new website). The host server can also broadcast a message to all control devices that are associated with the current session to update their URL bar widgets to reflect the new active URL. Herein we also provide examples that outputting of digital media content and control element interfaces onto separate devices allows for further flexibility and optimization beyond web browsing. In general, the construction of control widgets allows for various, flexible, and customizable user interfaces (“skins”) optimized for any given application theme, including Internet radio or video applications.

To leverage a user's awareness and comfort with the native user interface controls of the user's mobile device, novel utilization of these pre-existing resident native controls that are already integrated into a resident operating system of devices such as smart-phones, tablets, or other various portable devices may facilitate users more easily and naturally selecting and controlling digital content via the server-based content control environment capabilities described herein. Utilizing these native controls, such as the keyboard and mouse, is also a beneficial solution in that native user interface controls are already commonly and abundantly resident on most mobile touch screen devices (e.g. smart-phone, tablet, etc.). One key benefit of this embodiment is a lighter weight device application because through the efficient utilization of the mobile devices' graphical user interface, rather than generating custom user interface software to the control interface may be developed and deployed with less overhead. Another key benefit of utilizing the mobile device as the control device is that the user does not need a dedicated remote control to manage the plurality of output devices, content sources, and home network host server. By utilizing the native user interface features of the mobile device, host server control features can be integrated with existing mobile device operating system features without requiring a separately downloadable application-specific user interface. Yet another benefit, from a developer's point-of-view, many of the existing mobile device native controls have already been user-experience optimized for usability as they have been rigorously developed and tested as part of their resident operating system. Also, users typically familiar with various control formats for controlling local content, so changing these native controls from their current and more commonly known configurations would not make sense. In the example of the device native keyboard, as per the pre-existing resident operating system, a fully functional and dynamically generated operating system that adjusts to client behavior and/or use aesthetics already exists. This may include features such as, but not limited to, keyboard changing due to screen orientation, language, keyword searching as appropriate by embedded application theme (e.g. a typical URL browser application versus a standard email application). This solution may also facilitate reducing the actual number of control devices used throughout the home. Furthermore, there is no risk of a dedicated controller becoming lost or quickly antiquated as it mostly likely not upgradeable. For example, a downloadable user interface (UI) application is more easily upgradable and integrates into pre-existing mobile devices that the user prefers to use. The native user interface capabilities of a mobile device may be used directly to control searching for web content on the mobile device while viewing selected content on a separate display device if both devices are within the same control zone.

This embodiment takes advantage of the resident native user interface controls on the mobile device touch screen to allow the device to be utilized as an alternate control device, which may be other than the originally intended design, when integrated into a home network system. For example, a mobile device's native controls can be easier to use across applications such as 1) a URL web browser, 2) audio/video (from selectable content list information), 3) single player (control device) games, and/or other entertainment applications (e.g. karaoke). It will be shown that a control device may use a socket-based messaging protocol provide the user with an experience where heads-up content presented by a host server application session can be manipulated with native gestures on a control device, including keystrokes on the control device native keyboard and finger movement on a track-pad area of the control device.

An example of utilizing the keyboard device native control includes keyword querying (e.g. typing and searching) by the user in a heads-down mode. This can benefit Internet website browser applications and associated web content searching. It may also benefit keyword-based searching for selectable audio/video content list information (e.g. albums, artists, etc.) that may be readily available within a home network system.

Various existing utilizations of mouse-pad device native controls can further be categorized into finger movement or (gesture) themes such as, but not limited to, 1) finger movement to instruct a mouse pointer, 2) finger extraction/retraction for pinch-to-zoom of viewable content size in a window or the actual screen window size itself, and/or 3) two-finger (up/down or left/right) movement to instruct a page scroll, all of which are described in further detail below.

1) Pointer—A mouse point function may be used in a browser application active session that is described elsewhere herein. A client may move a finger within an allocated portion of the control device screen mouse-pad in a heads-down mode to generate a command (or request) that may be transmitted to a host server. The host server may in response cause a viewable pointer that is shown heads-up on a client selected output device to be manipulated by the user's finger movement in the allocated portion of the user's heads-down device interface.

2) Pinch-to-zoom—Furthering the mouse-pad pointer (gesture) example described above, the user can either extract/retract the separation distance between their pointer finger and thumb (mimicking a pinching gesture) heads-down on the aforementioned allocated portion of the control devices screen. Through software adapted to accept a representation of this mouse-pad input the content control methods and systems described herein may translate the client finger movement request into a response that is viewable in heads-up mode on a client selected display device. The pinching gesture may, for example, increase the browser application session window size as viewed on the display device or increase/decrease (zoom) the viewable content size within the session window.

3) Scrolling—As another mouse-pad (gesture) example, the user can move his/her fingers (e.g. left/right, up/down, or any combination thereof) to instruct a page scroll action in heads-down mode on the allocated portion of the control screen. The movement is converted into a command (or request) that may be transmitted to a host server. In response corresponding content that is displayed in a heads-up mode may be impacted by a viewable “scrolling” effect.

It will be shown that the device native controls, as described in this disclosure may be implementable through basic frameworks of graphical user interface (GUI) environments, such as, Linux operating system based XServer.

Host server managed application sessions for non-discriminative control of one or more control devices that have access to said host include various application types each with potentially unique method flows. Within these method flows are candidate examples where the host server manages the separation of content and control cognizant of the various application types the control devices. Particular application types may include, but are not limited to, applications such as 1) a URL web browser, 2) audio/video (from selectable content list information), 3) single player games, and/or entertainment applications (e.g. karaoke).

Also, host server managed sessions may include a client manager function communicate specifications related to the activated application sessions such as, but not limited to, permissions/access, unique identifier, and user profile. The host server communication may also include authorizing a control device to communicate with the host server in response to receiving an initialization request from any of the currently activated control devices. Such initialization request may be generated by a user action that may be performed in a heads-down mode via a device's native controls. The method also includes accepting a user's selection of any output devices that are shown as available in a heads-down control device screen. The user's selection may be based on at least the status information associated with the plurality of outputs connected to the network system. Further the method includes the host serving activated session content heads-up on the selected output devices (e.g. audio, video). Also, the method includes management of communication between control device and host server (over a network protocol including socket communication). The communication can be a request-response from the control device to host server, from host server to a control device, or a non-discriminative broadcast (“push”) communication from the host server to multiple control devices. Within the control device, messages containing session state or other information from a host server may trigger changes in control device user interface aesthetic, layout, or behavior. Within a host server, messages from a control device may trigger execution of any number of functions, including manipulations of any number of heads-up output devices (e.g. audio, video).

Additionally, cognizant of the browser application method flow, the control facility includes control elements in both the heads up mode on a host server and in the heads down mode on control devices. A chrome widget such as a “Back” button is entirely heads-down, while a mouse-pointer has a heads-down track pad interface and heads-up visual feedback of associated pointer movement. Further, the method includes changing the presentation state heads-up in response to receiving a command from a control device and associated device native control gesture movements heads-down.

Cognizant of the audio/video application method flow, a user can make a content item selection purely heads-down and output devices stream the selected digital content with no control information in the heads-up mode. Further, the method includes host server receiving a content item and output device (audio or video) selection request from any of the said control devices with access to the home network system. Also (as previously stated as above), the method includes broadcasting to any of the control devices session state information and/or associated digital content item selections heads-down both simultaneously and/or in a plurality of active sessions non-discriminately if there are more than one control devices receiving the broadcast.

These and other systems, methods, objects, features, and advantages of the present invention will be apparent to those skilled in the art from the following detailed description of the preferred embodiment and the drawings. All documents mentioned herein are hereby incorporated in their entirety by reference.

Methods and systems of audio/video distribution by a host interacting with a plurality of control devices that are treated as a single control device may comprise a method of distributing video and audio to at least one audio/video output device during a control session. This method may include several steps, such as receiving distribution control data from at least one audio/video control application executing on a mobile device, wherein the distribution control data corresponds to user actions in a user interface native to the mobile device; facilitating presentation of control elements associated with the control session on the mobile device based on a determination of which user actions in the native user interface constitute control actions and which user actions in the native user interface constitute content manipulation actions; delivering content that is determined based on the received distribution control data for presentation through the at least one audio/video output device; processing the received distribution control data to manipulate a content interaction indicator that is presented on the at least one audio/video output device; and updating a plurality of audio/video control enabled mobile devices with control session metadata based on at least one of the delivered content and the distribution control data.

In this method the content interaction indicator may facilitate interacting with content presented on the at least one audio/video output device. Also in this method, the plurality of audio/video control enabled mobile devices may each execute an instance of the audio/video control application. Distributing in this method may be based on the received distribution control data. The audio/video control application in this method may determine which user actions in the native user interface constitute control actions and which user actions in the native user interface constitute content manipulation actions. Like wise determining if a user action in the native user interface is for control or content manipulation may be based on a context of at least one of the control session and the content. Further in this method, the audio/video control application may receive data representing control elements for presentation of graphical control elements to the user. The control actions in this method may result from user actions that manipulate the presented control elements. In embodiments of this method, the audio/video control application may be one of a plurality of instances of the mobile audio/video control application executing on a plurality of mobile devices. In this method, the content interaction indicator may be capable of being manipulated by any of the plurality of mobile devices. It may also comprise a web browser-like pointer presented on the audio/video output device. Alternatively, the content interaction indicator may comprise a change in visual representation of a content item based on a user content manipulation action. Also, the content interaction indicator may comprise metadata associated with a content item presented on the audio/video output device.

The control status in this method may be pushed from the host to each of the plurality of mobile devices in response to any of the plurality of mobile devices impacting the status.

Additionally, presenting content in this method that is determined based on the received distribution control data on the at least one audio/video output device may include transmitting at least one of an HDMI signal and an audio signal via a corresponding output port of a host server to a corresponding input port of the at least one audio/video output device.

Methods and systems of audio/video distribution by a host interacting with a plurality of control devices that are treated as a single control device may comprise a method of distributing video and audio over a network to at least one audio/video output-capable device during a control session. This method may include a set of steps as follows: receiving distribution control data over the network from at least one audio/video control application executing on a mobile device, wherein the distribution control data corresponds to user actions in a user interface native to the mobile device; facilitating presentation of control elements associated with the control session on the mobile device based on a determination of which user actions in the native user interface constitute control actions and which user actions in the native user interface constitute content manipulation actions; delivering content that is determined based on the received distribution control data over the network to the at least one audio/video output device; processing the received distribution control data to facilitate manipulating a content interaction indicator that is presented on the at least one audio/video output device; and updating a plurality of audio/video control enabled mobile devices via the network with control session metadata based on at least one of the delivered content and the distribution control data.

In this method, the content interaction indicator may facilitate interacting with content presented on the at least one audio/video output device. Also, the plurality of audio/video control enabled mobile devices may each execute an instance of the audio/video control application. Distributing in the method may be based on the received distribution control data.

The audio/video control application in this method may determine which user actions in the native user interface constitute control actions and which user actions in the native user interface constitute content manipulation actions. Determining if a user action in the native user interface is for control or content manipulation may be based on a context of at least one of the control session and the content. Also, the audio/video control application may receive data representing control elements for presentation of graphical control elements to the user. This method may also include control actions resulting from user actions that manipulate the presented control elements. In this method, the audio/video control application may be one of a plurality of instances of the mobile audio/video control application executing on a plurality of mobile devices.

The content interaction indicator may be capable of being manipulated by any of the plurality of mobile devices. It may also comprise a web browser-like pointer presented on the audio/video output device. Likewise it may include a change in visual representation of a content item based on a user content manipulation action. Also, the content interaction indicator may comprise metadata associated with a content item presented on the audio/video output device.

This method may also include pushing status of the control session from the host to each of the plurality of mobile devices in response to any of the plurality of mobile devices impacting the status.

The network in this method may be a personal network configured in a user's residence.

Methods and systems of audio/video distribution by a host interacting with a plurality of control devices that are treated as a single control device may comprise a system for distributing video and audio over a network during a content distribution control session. This system may include aspects of an audio/video application, a host server, and a content interaction indicator as follows. This system may include an audio/video control application executing on a mobile device for preparing distribution control data that corresponds to user actions in a user interface native to the mobile device. It may include a host server that receives and processes the distribution control data that is prepared by the a/v control application, wherein the host server comprises a plurality of audio and/or video output ports adapted to provide output to at least one audio/video output device and at least one facility for accessing a plurality of content sources. Additionally, it may include at least one content interaction indicator adapted for presentation on the at least one audio/video output device that visually depicts user actions in a content interaction indicator portion of the user interface of the mobile device.

Such a system may include a content interaction indicator that facilitates a user of the mobile device interacting via the native user interface with content presented on the at least one audio/video output device.

In this system, the audio/video control application may be one of a plurality of instances of the audio/video control application, wherein each instance is executable on individual mobile devices. The audio/video control application may also determine which user actions in the native user interface constitute control actions and which user actions in the native user interface constitute content manipulation actions. Further in this system the audio/video control application may receive data representing control elements for presentation of graphical control elements to the user. The audio/video control application of this system may be one of a plurality of instances executing on a plurality of mobile devices.

In this system distribution control data may result from user actions that manipulate the presented control elements. This system may also include audio and/or video that may be retrieved by the host server based on the received distribution control data. Determining if a user action in the native user interface in this system is for control or content manipulation may be based on a context of at least one of the content distribution control session and the retrieved content.

In this system content interaction indicator may be capable of being manipulated by any of the plurality of mobile devices. It also may comprise a web browser-like pointer on the audio/video output device; a change in visual representation of a content item based on corresponding user actions in the native user interface; and/or metadata associated with a content item presented on the audio/video output device.

This system may further include status of the control session that is pushed from the host server to each of the plurality of mobile devices in response to any of the plurality of mobile devices impacting the status. Additionally, the plurality of audio/video output ports may comprise at least one of an HDMI signal port and an audio signal port.

Methods and systems of heads-up content item selection by a plurality of control facilities that are treated as a single control facility in an audio/video control session zone may include a method related to a zone-based content distribution control session. Such a method may include steps, such as: configuring at least one mobile distribution control device and at least one audio/video output device in a content distribution control session; receiving control data representing user interaction with distribution control elements of a user interface native to the at least one mobile device; retrieving content items from one or more content sources to satisfy a content query aspect of the received control data; distributing at least one of the retrieved content items to the at least one audio/video output device; receiving content selection input data from the at least one mobile device that corresponds to user interaction with a content interaction indicator zone of the native user interface; and selecting at least one of the distributed content items based on matching a location of a content item on the audio/video output device to content interaction indicator zone location information in the received content selection input data.

This method may include distributing that is based on the received control data. The retrieved content items in this method may be selectable via the mobile device's native interface. The method described herein may restrict content items selected in a control session to be selectable only by mobile devices configured in the control session.

In this method, content items distributed to the at least one audio/video output device may be selectable through the mobile device's native interface via manipulation of a content interaction indicator. Such a representation of the content interaction indicator may be presented on at least one of the plurality of audio/video output devices. This representation of a content interaction indicator may comprise a web browser-like pointer presented on the audio/video output device; a change in visual representation of a content item based on a user content manipulation action; and/or metadata associated with a content item presented on the audio/video output device. The content interaction indicator in this method may be capable of being manipulated by any of the plurality of mobile devices.

Distributing in this method may comprise transmitting at least one of an HDMI signal and an audio signal via a corresponding output port of a host server to a corresponding input port of the at least one audio/video output device. Alternatively, distributing may comprise transmitting the at least one retrieved content item via an IP-based network to the at least one audio/video output device.

Methods and systems of heads-up content item selection by a plurality of control facilities that are treated as a single control facility in an audio/video control session zone may include a system that may include several elements as follows: a content control and distribution session controller configured to service a plurality of mobile distribution control devices and at least one audio/video output device; a content interaction indicator associated with the session controller, wherein the content interaction indicator is responsive to user interaction with a content interaction indicator zone of a user interface native to at least one of the plurality of mobile distribution control devices; session operational data that corresponds to user interaction with distribution control elements of the native user interface; a content sourcing facility of a host server for retrieving content items from one or more content sources to satisfy a content query aspect of the session operational data; and a processor associated with the host server, the processor controlling distribution of at least one of the retrieved content items to the at least one audio/video output device in response to an output device selection criteria of the session operational data.

In this system session operational data received from any of the plurality of distribution control devices may be used by the content sourcing facility and the processor without requiring unique identification of the distribution control device from which the session operational control data originates. Also, the plurality of mobile distribution control devices may be a subset of a plurality of distribution control-enabled mobile devices that are logically connected to a client manager of the host server. Likewise, the host server may broadcast status of the session to the plurality of client manager-connected mobile devices in response to any of the plurality of mobile distribution control devices impacting the session status.

Methods and systems of device non-discriminative heads down content item selection with control status pushed to participating mobile devices may include a method for distributing content and pushing control session status as follows: distributing content from a host server to at least one audio/video output device that is defined in a control session, wherein distributing is based on distribution control actions that correspond to user input to a user interface native to any of a plurality of remote audio/video control-enabled mobile devices, and wherein the distributed content that is indicated by at least one content item that is presented in the native user interface is displayed on the at least one audio/video output device in response to a user selection of the content item; and pushing control session status that identifies at least one mobile device distribution control action to the plurality mobile devices. In this method, content items may be selectable from a list of content items presented in the native user interface.

Methods and systems of host-based audio/video control zone configuration, operation, and maintenance may include a method of host-based content distribution control zone operation that may include the following steps: establishing with a content distribution host server a plurality of audio/video control zones that each comprise at least one audio/video output device participant, at least one audio/video control zone enabled mobile device participant, and at least one audio/video connection between one of a plurality of independently controllable audio/video output ports of a host server and the at least one audio/video output device participant; controlling at least a portion of content provided over the at least one audio/video connection based on distribution control data received by the host server that corresponds to mobile device user actions in a user interface native to at least one audio/video control zone enabled mobile device associated with a specific control zone; and pushing control session status that identifies at least one action taken by the host server in response to the received distribution control data to a plurality of audio/video control zone enabled mobile devices, wherein at least one of the plurality of audio/video control zone enabled mobile devices is not a participant in a control zone for which the action was taken by the host server.

In this method an audio/video control zone enabled mobile device may comprise an audio/video control application that facilitates interfacing the native user interface to the host server by receiving input from the native user interface and providing distribution control data to the host server. The audio/video output device in this method may be configurable in only one audio/video control zone, whereas a mobile device may be configurable in one or more audio/video control zones.

In this method, output devices may be variably configured so that a first portion of an output device is configurable in a first audio/video control zone and a second portion of the output device is configurable in a second audio/video control zone. This method may include automatically configuring a second audio/video control zone to include all audio/video control zone enabled mobile device participants in response to an audio/video control zone enabled mobile device participant of a first zone requesting that a portion of an output device in the first zone be configured for use by the second zone.

In this method of host-based audio/video control zone configuration, the content provided over the audio/video connection may be manipulated by the host server to effect control actions based on the received distribution control data.

Methods and systems of host-based audio/video control zone configuration, operation, and maintenance may include a system that includes: an audio/video distribution host for sending a plurality of audio and video signals through a plurality of independently controllable audio and HDMI outputs to a plurality of audio/video output devices as determined from control data provided by a plurality of wireless audio/video control devices; the host adapted to establish a plurality of audio/video control zones that each comprise at least one audio/video output device, at least one wireless audio/video control device, and at least one audio/video signal; the host further facilitating control of at least a portion of the at least one audio/video signal by a user using a user interface native to a wireless control device configured in a zone with an audio/video output device; and the host further pushing control session status that identifies at least one host control zone status update action to a plurality of control devices.

Methods and systems of host-base content control zone configuration, operation, and maintenance may include a method of host-based content distribution control zone operation. Such a method may include functional steps for establishing control zones, controlling content in the zones, and pushing control zone status to participants. These steps may be described in detail as follows: establishing with a content distribution host server a plurality of audio/video control zones that each comprise at least one audio/video output device participant, at least one audio/video control zone enabled mobile device participant, and at least one logical connection over a network between the host server and the at least one audio/video output device participant; controlling at least a portion of content provided over the at least one logical connection associated with a specific control zone based on distribution control data received by the host server that corresponds to mobile device user actions in a user interface native to at least one audio/video control zone enabled mobile device associated with the specific control zone; and pushing control session status that identifies at least one action taken by the host server in response to the received distribution control data to a plurality of audio/video control zone enabled mobile devices, wherein at least one of the plurality of audio/video control zone enabled mobile devices is not a participant in the specific control zone.

In this method, an audio/video control zone enabled mobile device may include an audio/video control application that facilitates interfacing the native user interface to the host server by receiving input from the native user interface and providing distribution control data to the host server.

While an audio/video output device in this method may be configurable in only one audio/video control zone, a mobile device may be configurable in one or more audio/video control zones. This method may include flexibly configured output devices so that a first portion of an output device is configurable in a first audio/video control zone and a second portion of the output device is configurable in a second audio/video control zone.

This method may also include automatically configuring a second audio/video control zone to include all audio/video control zone enabled mobile device participants in response to an audio/video control zone enabled mobile device participant of a first zone requesting that a portion of an output device in the first zone be configured for use by the second zone.

To effect control actions based on the received distribution control data, the content provided over the logical connection is manipulated by the host server.

Methods and systems of host-base content control zone configuration, operation, and maintenance may include a method of presentation to a group, comprising: configuring a control session zone comprising a control device and an IP-enabled output device; facilitating access to attendees of the group to participate in the control session zone; facilitating automatic configuration of a second control session that includes the control device, the participating group members, and a portion of the output device; and operating the control device to instruct a host server to communicate with the output device over an IP-enabled network to facilitate presenting content selected by at least one of the user of the control device and at least one of the participating group members on the output display. In this method the selected content may be presented in the portion of the output device. Alternatively, the selected content associated with the control session zone may be presented on the output device and a selected content associated with the second control session is presented in the portion of the output device.

Methods and systems of content placement based on a session context in either heads-up or heads-down content selection may include a method of steps comprising: dynamically determining a destination device for content among a plurality of possible destination devices based on an audio/video control session context; sending first content to a heads down display of a user interface native to a control device; and sending second content to a heads up display, wherein the control device and the display are related through the audio/video control session. In this method, the first content may include visual graphical control elements, chrome control elements, and/or second content-specific election data. The second content-specific selection data may be a list of second content items.

The control session context in this method may indicate which types of content should be directed to a heads down operational device and which other types of content should be directed to a heads up display. Types of content for directing to a heads down device may comprise any one or more of chrome control elements, control widgets, visual graphical interface elements, and heads-up content selection data. In this method, the control session context may indicate that control-related content is presented on the heads down display and content derived from the control-related content is presented on the heads up display.

Methods and systems of content placement based on a session context in either heads-up or heads-down content selection may include a method of steps comprising: configuring at least one mobile distribution control device and at least one output device in a content distribution control session; receiving control data representing user interaction with application control elements of a user interface native to the at least one mobile device; retrieving content items from one or more content sources to satisfy a content query aspect of the received control data; distributing at least one of the retrieved content items to the at least one output device; receiving content manipulation data from the at least one mobile device that corresponds to user interaction with a content interaction indicator zone of the native user interface; and adjusting an output of the distributed at least one retrieved content item based on matching a location of a content item on the audio/video output device to content interaction indicator zone location information in the received content selection input data.

In this method the user interaction may be a pinching action. Further in this method, adjusting an output may comprise shrinking an image of the content item being presented on a display of the output device. Alternatively, adjusting an output may comprise dimming a display of the output device. Also, adjusting an output may comprise reducing an audio volume of the content item being presented on the output display. Adjusting an output in this method may include any of: enlarging an image of the content item being presented on a display of the output device; brightening a display of the output device; increasing an audio volume of the content item being presented on the output display; scrolling an image of the content item being presented on a display of the output device, and the like.

The user interaction may be a widening of a distance between two finger or a swipe of at least two fingers.

Methods and systems of content placement based on a session context in either heads-up or heads-down content selection may include a method of host-based content distribution control zone operation, comprising: establishing with a content distribution host server an audio/video control session that comprises at least one audio/video output device in an audio/video control zone, at least one audio/video control enabled mobile device participant, and at least one audio/video connection between one of a plurality of independently controllable audio/video output ports of a host server and the at least one audio/video output device participant; controlling at least a portion of content provided over the at least one audio/video connection based on distribution control data received by the host server that corresponds to mobile device user actions in a user interface native to at least one audio/video control enabled mobile device associated with a specific control zone; analyzing the control data for output zone request information and based thereon adding at least one output zone to the control session so that the at least a portion of the content is delivered to at least one output device in the added output zone; and pushing control session status that identifies at least one action taken by the host server in response to the received distribution control data to a plurality of audio/video control enabled mobile devices, wherein at least one of the plurality of audio/video control enabled mobile devices is not a participant in a control session for which the action was taken by the host server. In this method, the added output zone is identified by the analyzed control data, and or an unused output zone. Alternatively, the at least one output device in the added output zone may be an unused output device.

Methods and systems of audio/video distribution by a host interacting with a plurality of control devices that are treated as a single control device may comprise an audio/video control device with an output/facility for controlling at least one audio/video device, and a module for distributing and synchronizing control functions for the audio/video device in user interfaces native to a plurality of mobile devices.

Methods and systems of audio/video control device may include an output/facility for controlling at least one audio/video device and a module for distributing and synchronizing control functions for the audio/video device in user interfaces native to a plurality of mobile devices, wherein the synchronized control functions are presented on a display screen of the audio/video device.

Methods and systems regarding client side session initiation may include a set of steps for session initiation including: launching an audio/video control application on a mobile device, wherein the audio/video control application initiates a first audio/video control session by communicating with a host server to facilitate managing a user heads-down experience via a user interface native to the mobile device with a client manager function; receiving a user selection of a first application that uses the native user interface for interacting with the user; presenting a selection of output devices that are capable of providing human cognizable output from the first application in the native user interface, wherein the selection of output devices is limited to output devices that are accessible by the host server and that are not currently allocated to an audio/video control session other than the first audio/video control session; receiving a user selection of an output device via the native user interface and communicating that selection to the client manager function; and receiving from the client manager function updated first audio/video control session information and facilitating presenting the updated session information in the native user interface.

Methods and systems regarding host-side session operation may include receiving with a client manager executing on a host server a keyword of interest from a user via an audio/video control application running on a mobile device, wherein the keyword is derived from user input to a control element of a user interface native to the mobile device; communicating data representing the keyword of interest to a session manager that directs the data to an application executing on the host server that is associated with a control session that links the application with the mobile device and with an output device connected to the host server; retrieving, with the host server, first content from a plurality of content sources based on relevance of the content to the keyword of interest; displaying the first content on the output device; receiving from the audio/video control application a user selection of an item of content presented in the first content, wherein the user selection is derived from a user action taken in a content interaction zone of a user interface native to the mobile device; retrieving second content from at least one of the plurality of content sources based on the selected item of content; displaying the second content on the output device; and transmitting updated control session status information to the audio/video control application.

In this method, displaying the first content and displaying the second content is independent of the appearance of the content interaction zone of the native user interface. Alternatively, displaying the first content and displaying the second content does not impact the appearance of the content interaction zone of the native user interface.

### BRIEF DESCRIPTION OF THE FIGURES

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 illustrates an example environment for the typical “prior art” depiction of a computer (otherwise known as a desktop PC) and associated peripherals for control (e.g. mouse, keyboard, etc.) along with associated peripherals for viewing (e.g. display device, etc.) with screen segments segregated by chrome elements for control and for viewing the digital content.

FIG. 2 illustrates an example environment of a home network system in accordance with an example embodiment of the present disclosure.

FIG. 3 is a schematic block diagram of a host server and system-level architecture utilized by a home network system in accordance with an example embodiment of the present disclosure.

FIG. 4 is a schematic block diagram of a host server utilized by a home network system in accordance with an example embodiment of the present disclosure.

FIG. 5 illustrates an example of the key embodiments within the invention as associated with the browser application for separation of chrome (or widget) control elements with the actual content itself and for utilization of control device native controls.

FIG. 6 is schematic block a diagram of host server and system-level architecture utilized by a home network system in accordance with the browser application example embodiment of the present disclosure.

FIG. 7 is a flow diagram of method for managing the separation of digital content from a host server to various control and output devices in accordance with the browser application example embodiment of the present disclosure.

FIGS. 8A-8E are sample interface illustrations in accordance with the browser application example embodiment of the present disclosure.

FIG. 9 is schematic block a diagram of host server and system-level architecture utilized by a home network system in accordance with the audio/video application example embodiment of the present disclosure.

FIG. 10 is a flow diagram of method for managing the separation of digital content from a host server to various control and output devices in accordance with the video/audio application example embodiment of the present disclosure.

FIGS. 11A-11B are sample interface and output device (user point-of-view) illustrations in accordance with the browser application session example embodiment of the present disclosure.

FIGS. 12A-12B are sample interface and output device (user point-of-view) illustrations in accordance with the browser application session example embodiment of the present disclosure.

FIGS. 13A-13B are sample interface and output device (user point-of-view) illustrations in accordance with the browser application session example embodiment of the present disclosure.

FIGS. 14A-14B are sample interface and output device (user point-of-view) illustrations in accordance with the browser application session example embodiment of the present disclosure.

FIGS. 15A-15C are sample interface illustrations in accordance with browser application example embodiment of the present disclosure.

FIGS. 16A-16C are sample interface illustrations in accordance with the video application example embodiment of the present disclosure.

FIGS. 17A-17C are sample interface illustrations in accordance with the audio application example embodiment of the present disclosure.

FIGS. 18A-18D are sample interface and output device (user point-of-view) utilizations in accordance with the audio application example embodiment of the present disclosure.

FIG. 19 depicts a block diagram of an embodiment of a system for facilitating content control by a plurality of mobile devices interacting with a host server that provides content to discrete output devices.

FIG. 20 depicts a flow diagram of interactions among a control device, a host server, and an output device for facilitating content control via control sessions hosted by the host server.

### DETAILED DESCRIPTION OF THE PREFERRED EMBODIMENT(S)

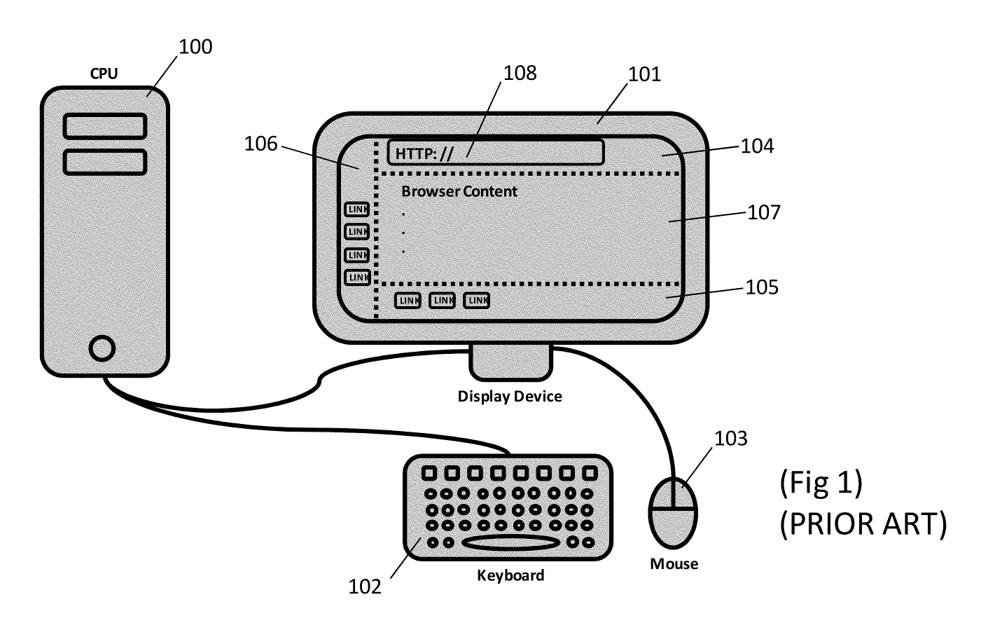

FIG. 1 illustrates a “prior art” example environment of a desktop computer or CPU 100. This familiar example environment includes a CPU 100 which comprises a display device 101 for viewing content and further including control peripherals, such as a keyboard 102 and mouse 103. All of the devices in this FIG. 1 environment are connected within the same proximity to each other and the user as the user needs to see what is being displayed on the screen 101 and needs to use the attached keyboard 102 and mouse 103 for control. In this example, the display device 101 screen typically the portions are allocated either for content viewing portion 107 or the static chrome (a.k.a. widgets) control elements, all of which comprise a single browser window. Furthermore, as shown in this FIG. 1 “prior art” a browser application session, chrome control elements are either static links (buttons) 104, 105, 106 for control or a static browser URL keyword search bar 108. Note that in this “prior art” sample implementation, both the content and associated control elements reside within the same display 101 window and connected control peripherals (e.g. mouse-pad, keyboard) restrict the chances for an optimized user experience such that the display device 101 control elements 104, 105, 106 are only presented heads-up in the same window as the displayed content 107.

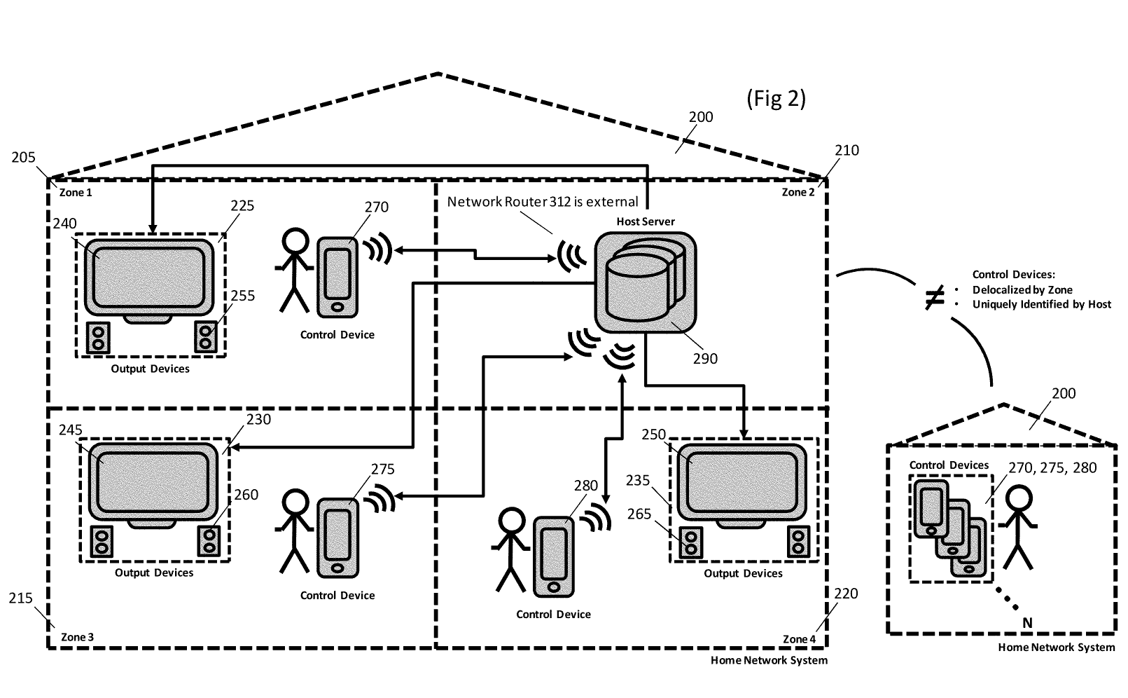

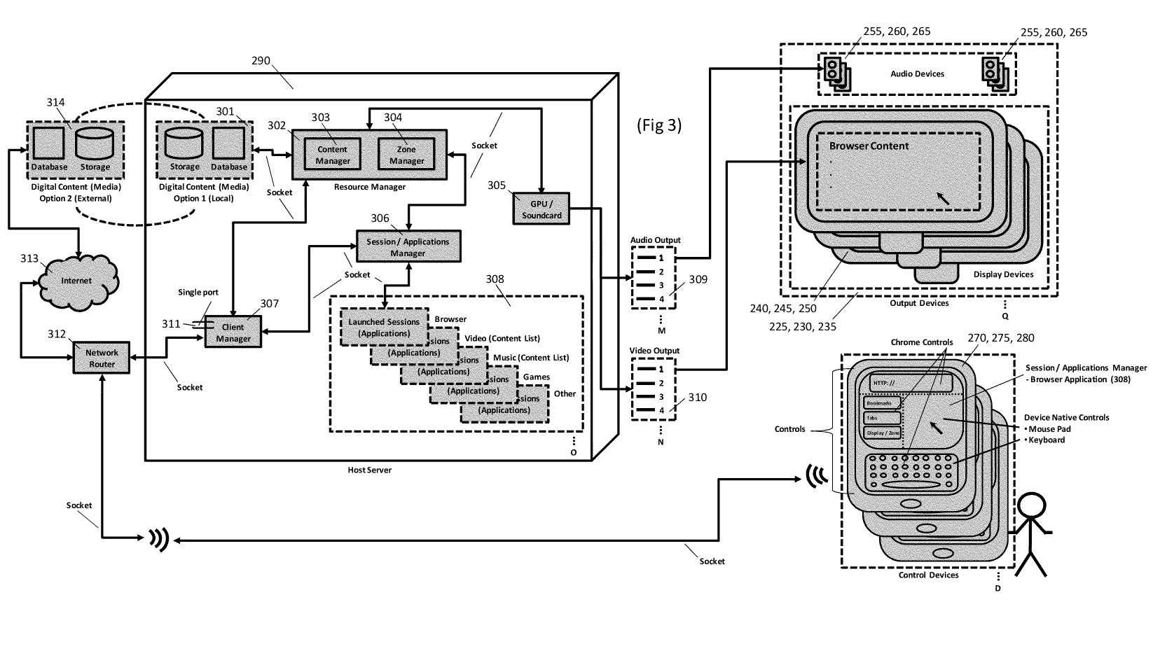

FIG. 2 illustrates an example environment of a home network system 200, according to an illustrative embodiment of the present disclosure. The home network system 200 includes various output devices 225, 230, 235 containing display devices 240, 245, 250 and/or audio devices 255, 260, 265, various control devices 270, 275, 280, and a host server 290. Further, in this embodiment each of the output devices 225, 230, 235 are connected to corresponding outputs (e.g. audio 309 and video 310 outputs of FIG. 3) of the host server 290.

FIG. 3 illustrates an example environment of a schematic block diagram of a host server 290 and system-level architecture of a home network system 200, as previously depicted in FIG. 2, according to an illustrative embodiment of the present disclosure. The home network system 200 of FIG. 2 includes various output devices 225, 230, 235 containing various display devices 240, 245, 250 and/or audio devices 255, 260, 265 further containing various control devices 270, 275, 280, and a host server 290. In an example embodiment, each of the output devices 225, 230, 235 are connected to corresponding outputs (e.g. audio 309 and video 310 outputs of FIG. 3) of the host server 290.

Each of the control devices 270, 275, 280 is communicatively connected to the host server 290. Any suitable wired and/or wireless connectivity technologies mentioned herein and known elsewhere can be employed to facilitate connection between any of the various control devices 270, 275, 280, various output devices 225, 230, 235 and the host server 290. The control devices 270, 275, 280 and host server 290 can communicate with each other by exchanging data packets according to a pre-defined set of network protocols, such as the Transmission Control Protocol/Internet Protocol (TCP/IP), the Real-time Transport Protocol (RTP), and the User Datagram Protocol (UDP), etc. A network protocol as used herein is a formal set of rules that define how data is exchanged between nodes (e.g. the control devices 270, 275, 280 and host server 290) in a communications network.

The control devices 270, 275, 280 can be conventional communication units, such as laptop computers, desktop computers, wireless transmit/receive units (WTRUs) (e.g. smart-phones and personal digital assistants (PDAs), and the like, that convert information (e.g., data) into signals that are transferred to an access point (e.g., network router 312) of the host server 290 via wireless links. More specifically, the control devices 270, 275, 280 are configured to connect to the home network system 200 of FIG. 2 and communicate with devices on the home network system 200 that can be, for example, a local area network (LAN).

The access point, or “single port” sockets 311 contains logic that enables the control devices 270, 275, 280 to transmit the information (e.g. data) to the host server 290. For example, socket 311 access points can include circuitry configured to receive signals (e.g. radio frequency (RF) signals), from the control devices 270, 275, 280, that carry the information via wireless links. Once the signals are received, the socket 311 access points convert the signals into data packets according the predefined set of network protocols. The socket 311 access points then pass the data packets to the host server 290. The host server 290 then processes the data packets to control and provide digital content to users via any of the requested combinations of the output devices 225, 230, 235. In addition, the socket 311 access points enable the host server 290 to connect to a wired/wireless local area network (e.g. the home network system 200 of FIG. 2).

The host server 290 includes at least one interface (e.g. output devices 225, 230, 235 and/or control devices 270, 275, 280) by which the output devices 225, 230, 235 are connected to the host server 290. In an example, the host server 290 can include a plurality of audio output interfaces, a plurality of video device 310 interfaces, and a plurality of audio device 309 interfaces and video display device 310 interfaces.

The output devices 225, 230, 235 can be connected to the interfaces of the host server via a High-Definition Multimedia Interface (HDMI) cable. HDMI is a compact audio/video interface for transferring uncompressed video data and compressed/uncompressed digital audio data from an HDMI-complaint device to a compatible digital audio device or digital television. In another example, the output devices can be connected to the host server via a wireless HDMI connectivity technology such as, for example, Sony Bravia Wireless Link ® utilizing, for example, a Wireless Home Digital Interface (WHDI) protocol standard for wireless HDTV connectivity that enables delivery of uncompressed high-definition video over a wireless radio channel connecting any video source (e.g., computers, mobile device, Blu-ray players) to any compatible display device.

As stated above, the output devices 225, 230, 235 may include display devices 240, 245, 250. These display devices 240, 245, 250 may be, for example, older generation televisions (e.g. cathode ray tube (CRT) televisions), Internet enable televisions, LEDs, LCD, mobile phones, smart-phones, computers, laptops, notebooks, tablets, etc. More specifically, these display devices 240, 245, 250 are any device types capable of displaying digital content to be viewed by a user.

Also, as stated above the output devices 225, 230, 235 may include audio devices 255, 260, 265. These audio devices 255, 260, 265 may be, for example, speakers and headphones. More specifically, the audio devices 255, 260, 265 are devices capable of playing any type of audio content such that a user is able to hear the audio content. The audio devices 255, 260, 265 can reside within various locations (zones) of a network system independent of the respective display device 240, 245, 250 locations, all of which is highly dependent on the application type.

In addition, the host server 290 includes a storage device that is configured to store digital content and is further configured to access digital content outside of itself on network attached storage (NAS). Digital content generally refers to information available for download or distribution on electronic media. For example, the digital content can include, but is not limited to, video, audio, digital media, documents, photos, or any other dynamically generated information. The digital content can be in several known formats such as, for example, mp3, MPEG, DIVX, MOV, JPEG, and WAV. A user may access the host server 290 via the local area network (LAN) and upload digital content to the host server 290. In another example, the user may access the host server 290 and download digital content from an external source (e.g., the Internet) to the host server 290.

In order to access the digital content, the user utilizes the control devices 270, 275, 280 to communicate with the host server 290. The control devices 270, 275, 280 obtain a communication address of the host server 290 (e.g. an IP address). For example, a user of the control devices 270, 275, 280 can register at least one of the control devices 270, 275, 280 to communicate with with/access the host server 290. The user may register the control devices 270, 275, 280 by signing into a central host server (not shown) using authentication information (e.g. username/password) of the user and associate the at least one of the control devices 270, 275, 280 with the host server 290. Once the at least one of the control devices 270, 275, 280 is registered, the at least one of the control devices 270, 275, 280 is able to communicate/access the host server 290 using the IP address of the host server 290 provided to the control devices 270, 275, 280 in response to registering with the central host server. The control devices 270, 275, 280 are able to communicate with the host server 290 via the socket 311 access points. Advantageously, the ability of the control devices 270, 275, 280 to communicate with the host server 290 is independent of the physical location of the control devices 270, 275, 280 with respect to the host server 290. In particular, the control devices 270, 275, 280 are able to communicate with the host server 290 as long as the control devices 270, 275, 280 are able to send communication signals to the socket 311 access points associated with the host server 290.

As will be described in further detail in the audio/video application type embodiment description, once the user is connected to the host server 290 via one of the control devices 270, 275, 280 the host server 290 provides the user with a list of the digital content 301, 314 either stored on (in 301) or accessed by (in 314) the host server 290. Next, the user selects a specific item of the digital content 301, 314, the host server 290 provides the user with an option as to which of the output devices 225, 230, 235 from which the user would like the selected digital content 301, 314 presented. For example, the host server 290 presents the user with a list of available output devices 225, 230, 235 using the unique identifiers associated with the interfaces by which the output devices 225, 230, 235 are connected to the host server 290. The user can then select from any one of the output devices 225, 230, 235, given the selected application. The option of output devices 225, 230, 235 presented to the user may be based on a current status of the output devices and/or the type of digital content requested by the user.

Another embodiment of the disclosure comprises a host server for managing and distributing digital media content in association with a network system that may include a plurality of computing devices with varying user interface features and capabilities as described throughout this invention. The host server may include one or more processors, a memory, and other circuitry generally included with a network-enabled host server that is connected to the Internet. In addition, the host server may include a client manager configured to receive, using the one or more processors, a request from a control device to deliver at least one item of digital content stored in the memory, or provided via Internet access through the network system, from the host server. The control device can be one control device among a plurality of control devices that have access to the host server anywhere the within a network system. Since there are typically more than one display device within a home network, the viewable content items, (e.g. web content windows) may be controlled and hosted through one central location (e.g. the host server) yet viewed simultaneously and controlled independently of each other throughout various output device locations (zones) that may be serviced by the home network. Distinct host servers in a commonly shared [symbol] network may be used as central nodes logically arranged between control devices in the network and output devices in the various zones while enabling access to Internet content.

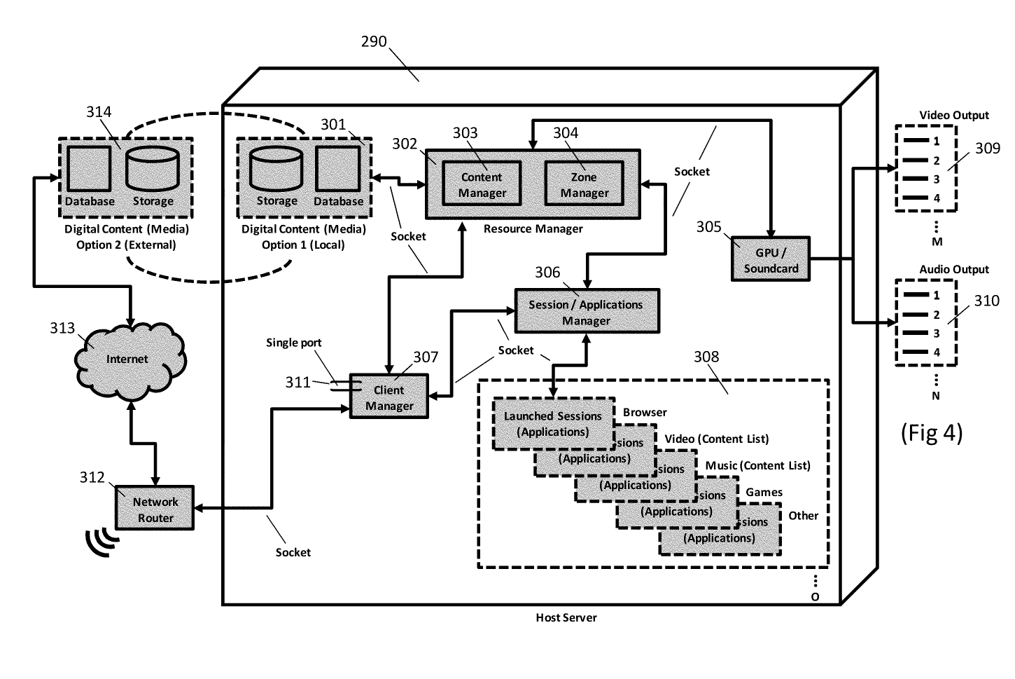

FIG. 4 is a schematic block diagram of a host server 290 utilized by a home network system (e.g. the FIG. 2 home network system 200 and a magnified view of the FIG. 3 host server 290). The host server 290 can include, but is not limited to, a network router 312, client manager 307, session/applications manager 306, launched application types 308, resource manager 302, content manager 303, zone manager 304, digital content (media) options 1 and 2 storage/database 301 (internal), 314 (external), Internet 313, GPU/soundcard 305, various session application types 308, and audio output interface 310 video output interfaces 309. Any suitable connectivity technologies mentioned herein may be employed to facilitate connection between the various devices 301-314.

The network router 312 is configured to function as a wireless access point via utilization of single port sockets 311. The router 312 provides the host server 290 with a connection to the Internet 313. More specifically, the router 312 can function in a wired local area network (LAN), wireless-only LAN (WLAN), or in a mixed wired/wireless network. As stated above, the network router 312 enables the control devices 270, 275, 280 to communicate with the host server 290.

The client manager 307 and associated single port socket 311 is configured to enable the host server 290 to deliver digital content to devices connected to a local area network (LAN) (e.g., the FIG. 2 home network system 200). In addition, the client manager 307 processes communications received from the LAN via the network router 312. Using the client manager 307, the host server 290 is able to communicate with and manage devices connected to the LAN. For example, the client manager 307 communicates with the control devices 270, 275, 280, resource manager 302, and the various active sessions application types 308 in order to manage and provide the digital content stored in either of the digital content (media) options 1 storage/database (local) 301 and options 2 storage/database (external) 314. Further note that the client manager 307 may be further configured to receive, using the one or more processors, a command from any one of a plurality of control devices 270. 275, 280 (depicted in FIG. 3) to serve via a selected output at least one item of digital content 301, 314, the session state information associated with the digital content 301, 314, or the session state information for the plurality of outputs 225, 230, 235 (as depicted in FIG. 3) of the host server 290, the selected outputs being selected by a user of the control devices 270, 275, 280 (as depicted in FIG. 3) based on at least the session state information associated with the plurality of outputs all of which are non-discriminately managed by and connected to the host server 290 within a home network system 200. The client manager 307 may be further configured to authorize access, using the one or more processors, between any one of the control devices 270, 275, 280 and the host server 290 in the network system 200 when receiving any request (e.g. initialization request) from any of said control devices. Also, the client manager 307 can be configured to associate, using the one or more processors, each of the plurality of control devices 270, 275, 280 with corresponding unique identifiers. These unique identifiers may be useful for certain functions based on a given the application types 308, or based on launched (active) session within a session/applications manager 306, which will be described later. Note that any of said control devices 270, 275, 280 are devices that communicate via two-way communication with the host server 290 and optionally with other control devices within the network system (e.g. transmit/receive unit (TRU) configured to communicate). The client manager 307 can be further configured to transmit/receive requests from the control devices 270, 275, 280 that may be uniquely identified in order to distinguish between one control device and another control device within the network system 200. The unique identification of the control devices 270, 275, and 280 may be based on the application type associated with a launched control session. This will allow the host server 290 to communicate session-specific state information to the unique and plural control devices 270, 275, 280 within the network system 200.

Also, the host server 290 may include a resource manager 302 configured to broadcast, using the one or more processors, to the plurality of control devices 270, 275, 280 session state information associated with the digital content 301, 314 and/or session status information, in response to receiving the corresponding request from one of the control devices. In addition, the resource manager 302 may be further configured to serve, using the one or more processors, at least one item of digital content 301, 314 and/or the session state information associated with the digital content in response to receiving the request from any one of the control devices 270, 275, 280 via a zone manager 304 capability of the resource manager 302.

The resource manager's zone manager 302 can be configured to associate, using the one or more processors, each of the plurality of outputs with a corresponding unique identifier. The zone manager 304, using the one or more processors, can be further configured to change a presentation state of the item of the digital content 301, 314 being served via the selected outputs 225, 230, 235 in response to receiving a command from any one of the control devices 270, 275, 280 that results in a change to the session state, such as the digital content presentation state. Also, the zone manager 304, using the one or more processors, can be configured to change the session presentation state of one output of the plurality of outputs 225, 230, 235 via which digital content 301, 314 is being served in response to receiving a command from any one of the control devices 270, 275, 280 to do so. The resource manager 302 associated content manager 303 can be configured to provide, using the one or more processors, all of the control devices 270, 275, 280 with a list of the digital content stored on the host server 290 internal storage/database or provided via Internet access connected to the network system 200 given the active session application types 308.

Once all the output interfaces 309, 310 have been identified and associated with a unique identifier, the zone manager 304 monitors the status of all the output interfaces 309, 310. The zone manager 304 performs this task by monitoring traffic flow from each of the output interfaces 309, 310. In addition, the zone manager 304 determines that session state information of the digital content stored by the host server 290 via the digital content storage/database 301, 314. For instance, the zone manager 304 determines whether an item of digital content (media) options 1 and 2 storage/database 301 (internal).

In an example embodiment, the client manager 307 receives a request for an item of digital content from any one of the control devices (e.g., the control device 270, 275, 280 of FIG. 2) via the network router 312. In addition, the client manager 307 receives a corresponding command that that identifies from which of the output interfaces 309, 310 to serve the digital content. The client manager 307 passes the request and corresponding command are passed to the resource manager 302 content manager 303. The content manager 303 retrieves the selected digital content from the digital content (media) options 1 and 2 storage/database 301 (internal) and processes and formats the digital content for standardization into the GPU/Soundcard 305 similar to, but not limited to, as that of either an Internet web-browser.

The session/application manager 306, using the one or more processors, can be further configured to monitor session state information of each of the plurality of outputs 225, 230, 235 and the digital content, maintain the session state information associated with each of the plurality of outputs and the digital content in the host server 290 memory or provided via the Internet, and provide the plurality of control devices 270, 275, 280 with the status information and the unique identifier associated of the control and output devices. Also, the session/application manager 306 can be further configured to simultaneously provide, using the one or more processors, the session state information to the plurality of control devices 270, 275, 280, given the various application types 308 and multiple active session instances thereof.

Another key embodiment of non-discriminative control is through socket input/output utilization which may use a custom protocol (e.g., socket-based messaging library) to communicate input/output information in streamlined and low-overhead messaging between the control device to host server for controlling digital content, session, and/or client/server information over a network. This is ideal as it enables efficient, real-time (live “open” socket) data exchange minimizing latency and size of the data. This implementation includes a control device and/or host server compatible library that parses, packages, and sends various strings (e.g. client/server information, commands, etc.). Such strings contain relevant data including sender identification, receiver identification, references to executable content, response data, etc. These strings are packagable and parsable in a standardized format (e.g. JSON, XML) such that a program with a message parsing and packaging library on a control device or a host server can interpret such a string (e.g. JSON parser) and handle it appropriately (e.g. execute a method, update a database with response data, etc.). Furthermore, such a library can be equipped to transmit and receive these messages using transport protocols, such as, but not limited to, TCP (transmission control protocol) socket. Other protocols that may alternatively be used in this implementation include UDP (user datagram protocol) for simpler messaging transmissions, DCCP (datagram congestions control protocol), SCTP (Stream Control Transmission Protocol) (SCTP), etc.

In contrast to the above example utilization, messages may also be delivered through the more commonly known use of HTTP. Currently, HTTP utilization is the standard protocol for websites (e.g. “HTTP://”). HTTP is a standard and stateless format to package, parse, and send information. Note that within computing, a stateless protocol is a communications protocol that treats each request as an independent transaction that is unrelated to any other previous request, allowing for independent pairs of requests and responses. Furthermore, a stateless protocol does not require the host server to retain any session state information through the multiple requests of a client-to-host server pairing. In contrast, a “stateful” protocol requires keeping the internal state on the host server. HTTP may be used for most commands that are sent from the control devices to the host server, which makes the functionality of the host server similar to that of more commonly known web-server from an I/O point of view of the control device (e.g. smart-phone, tablet, etc.).

Socket connections may be primarily used without HTTP as it allows the host server to “openly” maintain connections throughout the duration of the active session. For example, in a typical browser application, the host server does not know if the control device (client) URL-page is actively “open” or if that session window has actually been terminated by the user. As utilized herein, active sessions (e.g. SBConnect, etc.) are observed at all times and actively have the ability to “push” messages whether it is in response to a request, or more broadly, a broadcast to multiple devices connected to the host server. Examples of this preferred embodiment for active sessions include 1) control device (client) initiated request to host server, 2) host server initiated broadcast (“push”) to control devices, 3) control device (client) handling response to host server broadcast, and 4) host server handling response to control device (client) request.

One key embodiment now described relates to how visual graphical interface control elements and the display content itself are separated in a browser application. The visual graphical interface control elements have been more commonly known as chrome elements, or widgets. In the typically known “prior art” (as previously depicted in FIG. 1) implementation of a computer CPU 100 with a keyboard 102, mouse 103, and monitor 101, since there is only one display for viewing both the control and content elements, there is no need to separate the depiction of control from the content onto separate devices as all associated devices, the user, and said peripherals (mouse/keyboard) are all within close proximity to each other. However, for the advanced control schemes that are enabled by the methods and systems described herein a plurality of control devices (e.g. smart-phones, tablets, etc.) generally have their own displays and are operated independently of other output devices (e.g. display devices) for viewing the content even though they may be within close proximity to a user. That said there is also ample opportunity to improve user experiences by taking advantage of the control device native capabilities while utilizing a proximal display device.

In a preferred embodiment, the host server can extract information from the typical URL browser window's chrome control elements (or widgets) and send said information to any of the available session control devices for use in a heads-down control mode. For example, a modified browser application session running on a host server may be configured to not display the typically associated chrome elements (or widgets) to a proximal display device, while tracking that information on the host server. The modified browser application session, managed by said host server, may further be instructed to respond to a control device request with chrome element information to be presented by the control device heads-down. The socket-enabled message parsing library of the control device may receive the message and update its user interface (e.g. associated browser application URL search bar) to reflect the newly discovered information (the URL). The user of the control device can interact with this chrome information via the control device native user interface features in order to manipulate the chrome control elements (or widgets). A control device may translate those manipulations into representative data from which the host server derives those commands into decision points from which user intended actions are achieved within the associated active session. These actions may include updating either the displayed content information for the chrome elements or both. A commonly known example of this is sending a “click on this link,” which updates the content view to a new website and a pushed notification of a new URL for the control device to display in the URL bar. The user of the control device can interact with this chrome information via the devices native user interface features to manipulate the chrome control elements/widgets. A control device may translate those manipulations into representative data from which the host server derives those commands into decisions points from which user intended actions are achieved within an active session.

The separation of the processes for outputting digital media content and control interfaces onto separate devices allows for further flexibility and optimization beyond web browsing. The construction of control widgets allows for various, flexible, and customizable user interfaces (“skins”) optimized for any given application theme. For example, within a browser application, the URL bar may be replaced with a “Station Search” bar for Internet radio, and “Forward, Back” chrome buttons may be replaced with “Play, Pause” buttons for said radio. In such an application type, the modified web browser program is replaced with a modified Internet radio application theme (also utilizing a socket-based messaging library) instructed to respond to control devices with the more specifically themed session state information (e.g. station selection, play-state, etc.). The proximal media content output, rather than a television output, is a stereo audio only output. More generally, as will be further described in detailed description of the browser application session, the chrome elements are extracted and pushed to the control devices (client observing heads-down) and the viewing content is pushed (client observing heads-up) to the selected display device where streaming digital content is more optimally viewed.

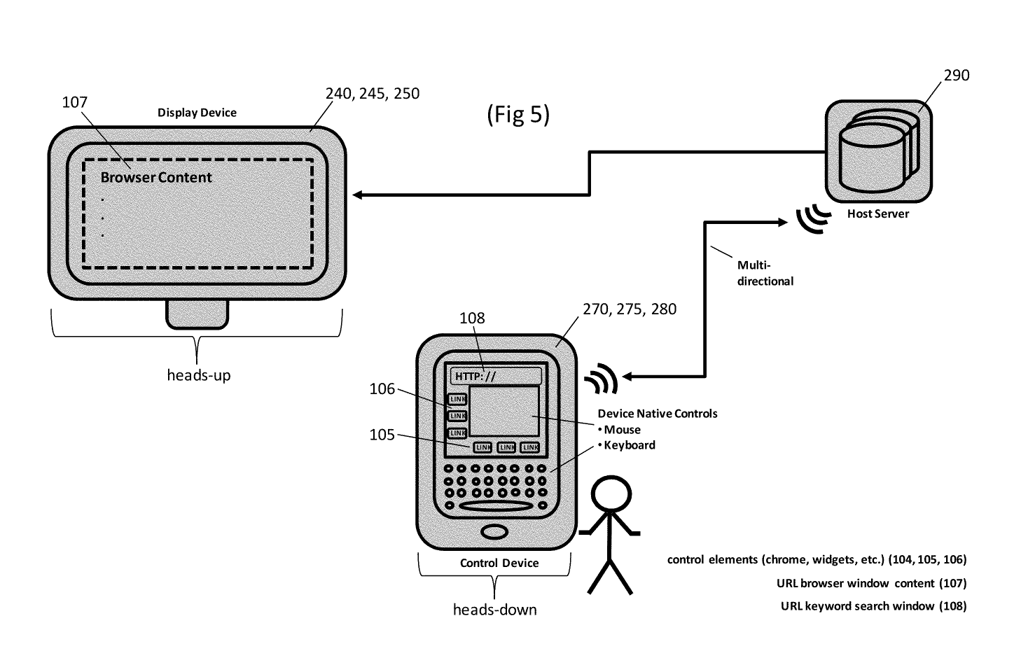

In further describing this preferred embodiment, FIG. 5 represents a browser application and the associated separation of the chrome control elements (105, 106) and the display content 107. More specifically, FIG. 5 depicts an Internet browser application session managed by host server 290, where the control devices 270, 275, 280 have chrome control elements 105 106, keyword URL search window 108 and associated device native controls (mouse-pad, keyboard) all of which are part of a heads-down user mode, and a display device 240, 245, 250 for viewing selectable content information that is separated from the chrome control information in a heads-up user mode. Within the previously described session applications 308, as shown in FIG. 3, an application may be a browser application type modified with a socket-enabled messaging library as described herein. This modified browser application connects to and browses the Internet, outputting digital content to an output device 240, 245, 250.

Any of the control devices 270, 275, 280 can request to launch a browser application session, so that it is distinct and independent from the modified browser application running on the host server 290. The launched browser application uses its socket-enabled messaging library to connect to the modified browser application on the host server 290 to exchange messages including such as, but not limited to, control commands (e.g. “click on this link,” keystroke commands, etc.), information requests (e.g. “what URL is currently active?”), responses to requests (e.g. currently active URL), and/or broadcast messages (e.g. “push” notifications such as “a client has closed tab 0”). The launched browser application session may include an application component (e.g. a web browser) executing on the control devices. This application component can be implemented using native device libraries for the control device (e.g. tablet, smart-phone, etc.) for chrome control elements 105 106, keyword URL search window 108 and associated device native controls (e.g. mouse-pad including gesture recognition, device optimized native keyboard). Further, the control device utilization of said active browser application type session (e.g. the locally executing web browser) is capable of behaving independently of the modified browser application executing on the host server 290 that is associated with the browser application session. This independent capability may include browsing, modifying bookmarks, and the like where the visual feedback to the user is entirely through the native user interface of the control device 270, 275, and 280 in a heads-down mode. This will allow for multi-tasking functionality within the context of an application session thereby letting users enjoy streaming digital content heads-up on designated output devices from the modified browser application while controlling both the locally executing and the modified browser applications heads-down on the control device, essentially utilizing its native features in parallel (e.g. manage bookmarks, begin next search, etc).

Another preferred embodiment leverages user awareness and comfort associated with the native control device interface to effect a novel utilization of these pre-existing resident native controls that are integrated in the control device resident device operating system and to further facilitate ease of select ability and digital content control environment capabilities described herein. The device native controls, as described in this disclosure may be implementable through basic frameworks of graphical user interface (GUI) environments, such as, Linux operating system based XServer, and the like. This particular framework is typically used to implement, query, or simulate user inputs and outputs, including keyboard, mouse, and monitor. The XServer is an abstraction layer within Linux OS, providing an interface for developers to create programs (typically on the same machine as the XServer, but not necessarily) to communicate with the Linux IO. In particular, the XServer running on a host server (capable of displaying heads-up content to any number of output devices) can be manipulated by an independent control device with the appropriate control application GUI (not necessarily running XServer) and network communication library (using socket messaging to manipulate a remote XServer on the host server). Utilizing these native controls, such as the keyboard and mouse, is also a beneficial solution in that native user interface controls are already commonly and abundantly resident on most mobile touch screen devices (e.g. smart-phone, tablet, etc.). Cognizant of these application types available for use with a control session and of the mobile device native control features, preferred embodiments are categorized into native control categories below. These typically are available with most mobile device operating systems and include 1) keyboard, 2) mouse-pad, 3) accelerometer, and/or 4) microphone and all of which are further detailed below.

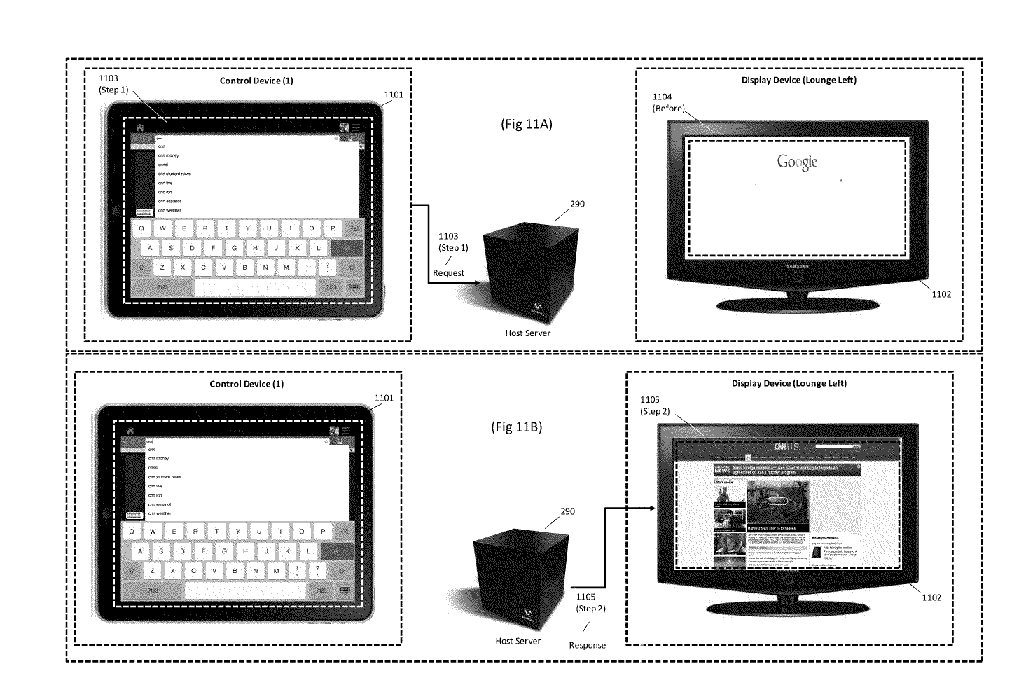

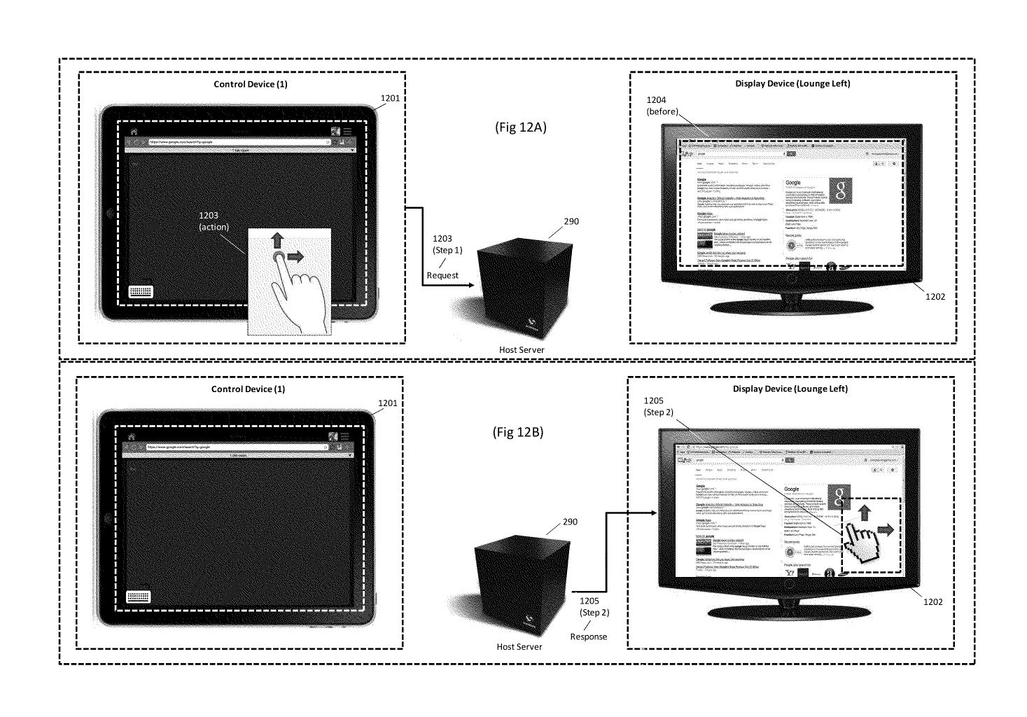

In an example of utilizing the keyboard device native control includes keyword querying (e.g. typing and searching) by the user in a heads-down mode. This can benefit Internet website browser applications and associated web content searching. It may also benefit keyword-based searching for selectable audio/video content list information (e.g. albums, artists, etc.) that may be readily available within a home network system. FIGS. 811A-11B represents an example utilization of a keyboard device native control in an Internet browser application where the keyboard is used for querying web content in a heads-down mode on a control device 1 1101. Keyboard entry, is shown in the FIG. 11A step 1 1103 in the URL browser search bar location of the application browser interface window. Once the user decides which display output device 1104 to receive the browser window and search query result content, the host server 290 may initialize the selected display device (e.g. Lounge Left 1102) as shown in the “before” 1104 screen view. Further depicted in FIG. 11B, the host server 290 responds in step 2 1105 to the request step 1 1103 by updating the browser window with search query result content for heads-up mode on the display device 1102.

Various existing utilizations of mouse-pad device native controls can further be categorized into finger movement or (gesture) themes such as, but not limited to, 1) finger movement to instruct a mouse pointer, 2) finger extraction/retraction for pinch-to-zoom of viewable content size in a window or the actual screen window size itself, and/or 3) two-finger (up/down or left/right) movement to instruct a page scroll, all of which are described in further detail below.

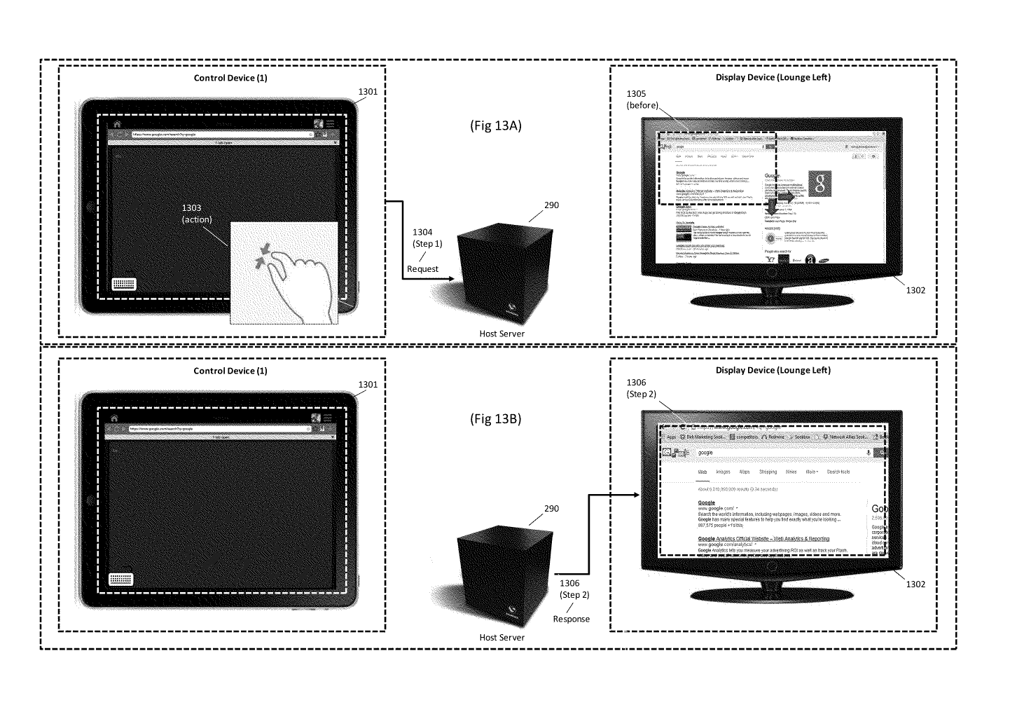

1) Finger movement to instruct a mouse pointer function may be used in a browser application active session that is described elsewhere herein. A client of a control device may move a finger within an allocated portion of the control device screen mouse-pad in a heads-down mode to generate a command (or request) that may be transmitted to a host server. The host server may in response cause a viewable pointer that is shown heads-up on a client selected output device to be manipulated by the user's finger movement in the allocated portion of the user's heads-down device interface. FIG. 12A-12B represents an example utilization of said mouse-pad device native control as the user (gesture) for pointer implementation as is depicted in a browser application session window, where a client moves their finger on the allocated portion of the control device screen heads-down on a control device 1 1201. Mouse pointer manipulation is shown in the FIG. 12A as action 1203, which is then translated into a command or request to be sent to the host server 290 shown in 1203 (step 1). Next, in FIG. 12B the host server 290 responds in step 2 12105 by transposing the user pointer movement 1205 viewable as a pointer on the display 1202 (Lounge Left) on the opened browser application window (previously depicted as “before” 1204 in FIG. 12A.

2) Finger extraction/retraction to instruct a pinch-to-zoom function may be used in a browser application active session that is described elsewhere herein. Furthering the mouse-pad pointer (gesture) example described above, the user can either extract/retract the separation distance between their pointer fingers and thumb (mimicking a pinching gesture) heads-down on the aforementioned allocated portion of the control devices screen. Through software adapted to accept a representation of this mouse-pad input the content control methods and systems described herein may translate the client finger movement request into a response that is viewable in heads-up mode on a client selected display device. The pinching gesture may, for example, increase the browser application session window size as viewed on the previously selected display device or increase/decrease (zoom) the viewable content size within the session window. FIGS. 13A-13B further represents the user (gesture) for pinch-to-zoom on the native device causes a zoom on the output device. The user can either extract/retract the separation distance between their pointer finger and thumb (mimicking a pinching gesture) on the aforementioned allocated portion of the control devices screen heads-down on a control device 1 1301, shown in the FIG. 13A as action 1303. The action is further translated as request to be sent to the host server 290 shown in 1304 (step 1). Next, in FIG. 13B the host server 290 responds in step 2 1306 by changing the viewable browser application window content state on the display device 1302 from what is previously depicted as “before” 1305 in FIG. 13A.

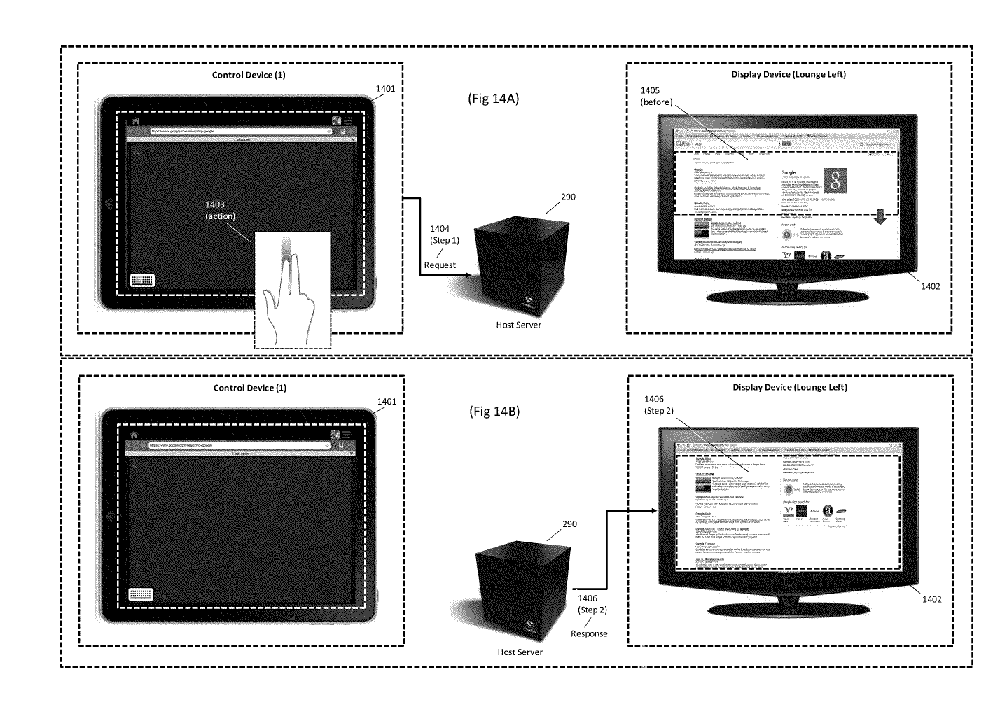

3) Two-finger up/down or left/right movement to instruct a scrolling function may be user in the browser application active session that is described elsewhere herein. In furthering to the other mouse-pad (gesture) examples above, the user can move his/her fingers (e.g. left/right, up/down, or any combination thereof) to instruct a page scroll action in heads-down mode on the allocated portion of the control screen. The movement is converted into a command (or request) that may be transmitted to a host server. In response corresponding content that is displayed in a heads-up mode may be impacted by a viewable “scrolling” effect. FIGS. 14A-14B further represent the described user gesture of moving two fingers (left/right, up/down, or any combination thereof) on the aforementioned allocated portion of the control screen heads-down on a control device 1 1401, which is shown in the FIG. 14A as action 1403 instructs a page scroll on the display device 1402. A command or request is sent to the host server 290 as shown in step 1 1404. Next, in FIG. 14B the host server 290 responds in step 2 1406 by changing the viewable browser window content state on the display device 1402 from what is previously depicted as “before” 1405 in FIG. 14A.

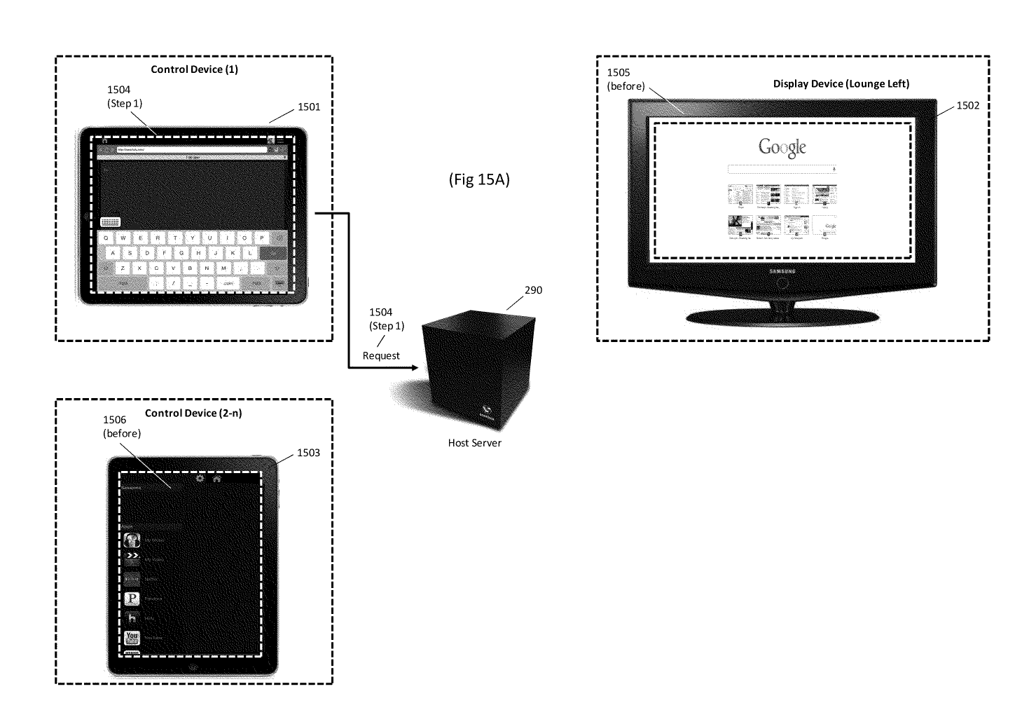

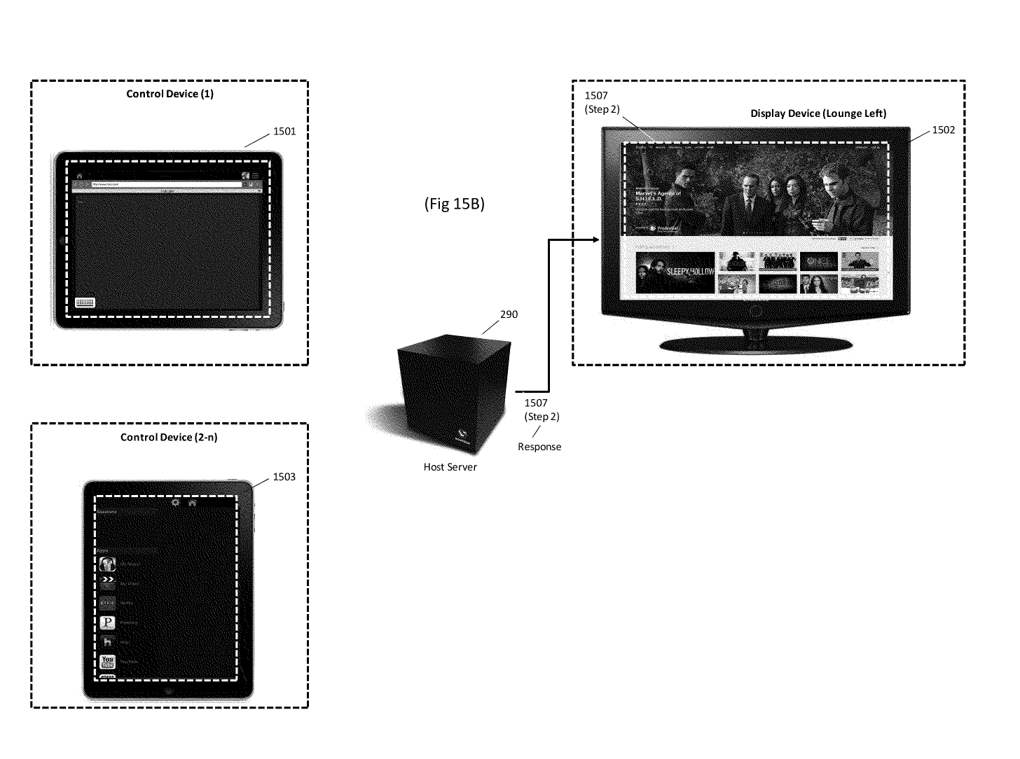

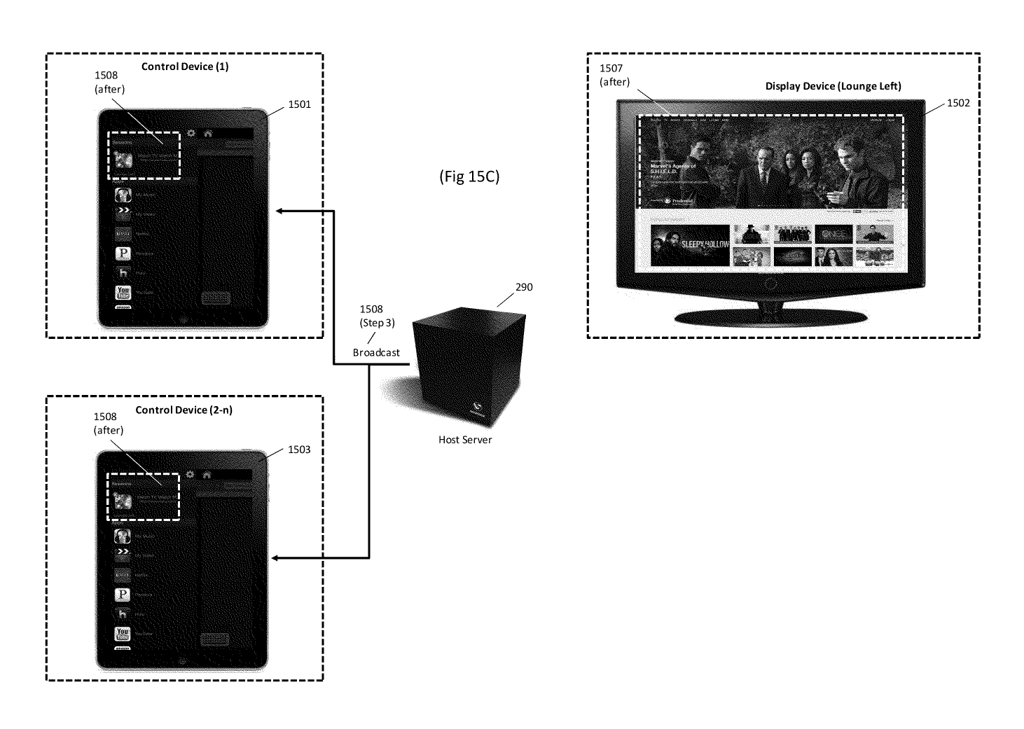

FIGS. 15A-15C exhibits utilization of device native controls for heads-down and heads-up mode operation by showing before (FIG. 15A) and after (FIGS. 15B and 15C) point-of-view from the multiple control devices and an output display device for an Internet browser application session. In this example, as shown in FIG. 15A in 1504 (step 1), the user uses the device native keyboard to query (request) web content in a heads-down mode on a control device 1 1501. This is translated into a request 1504 for the host server 290 to update the display device 1502 (Lounge Left) shown as step 1505 (before) that is currently configured as the output device for the Internet browser application session. Further note, the “before” state 1506 of the secondary control device (2-n) 1503 which is not initiating the request 1504 (step 1), but has an active control session connection to the host server 290. Next, in FIG. 15B the host server 290 responds 1507 (step 2) and accordingly changes the viewable browser window content state on the display device 1502 from what is previously depicted as “before” 1505 in FIG. 15A. Also, as shown in FIG. 15C, the host server 290 broadcasts the session state update to the control devices 1501, 1503 that have an active control session connection to the host server 290. In this example, both control device (1) 1501 and control devices (2-n) 1503 as depicted in 1508 (step 3) receive the updated session state for updating the mobile device's heads-down view.

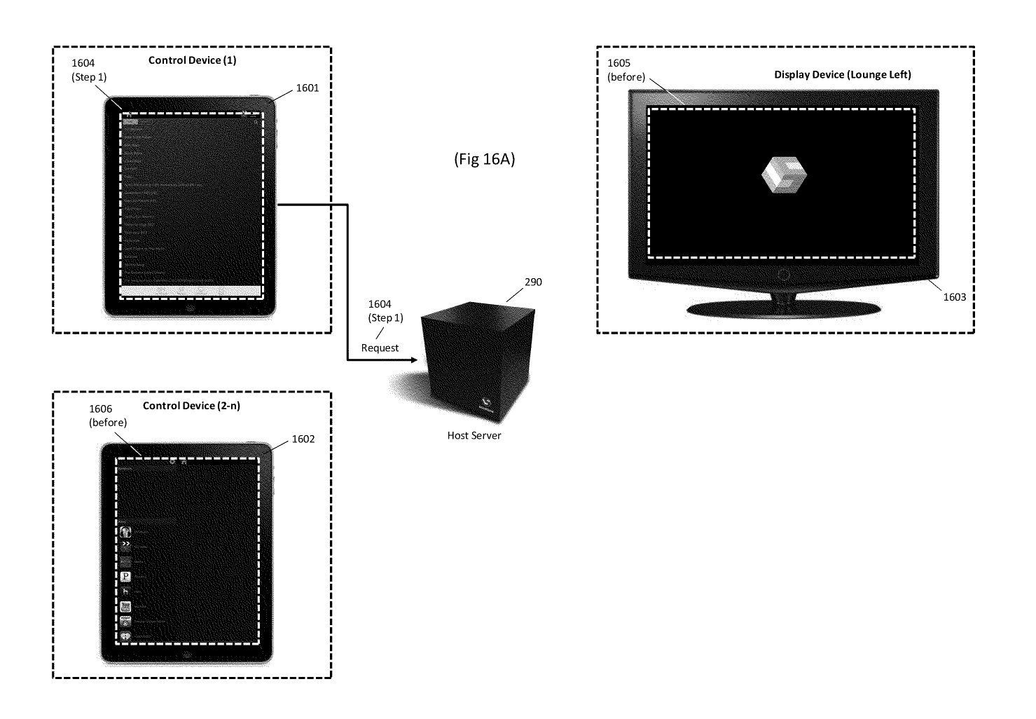

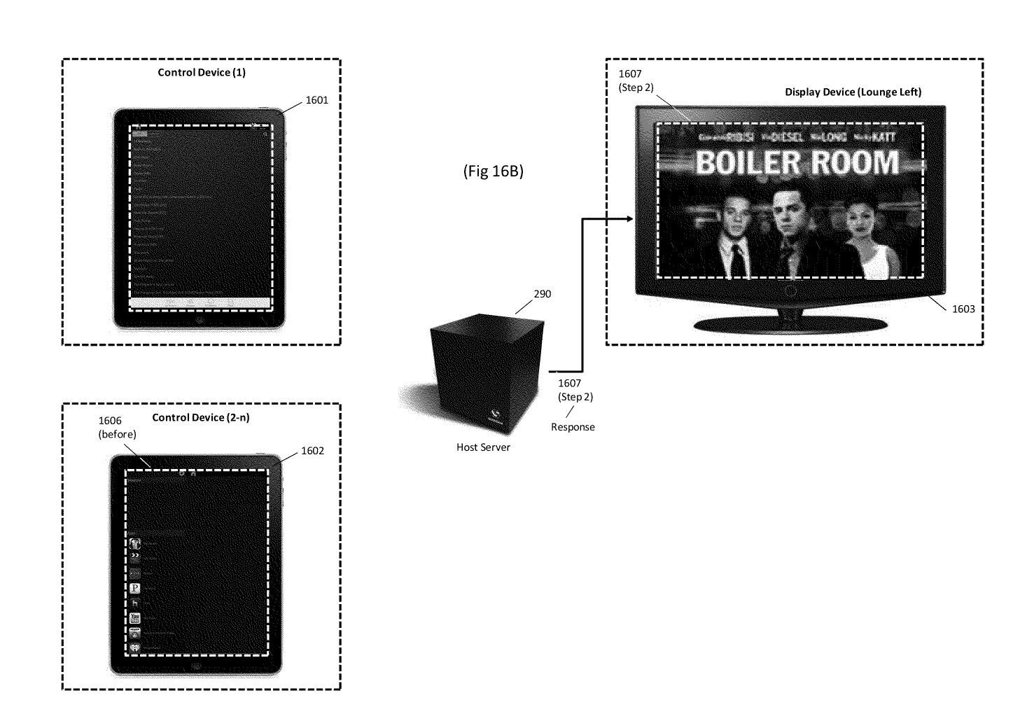

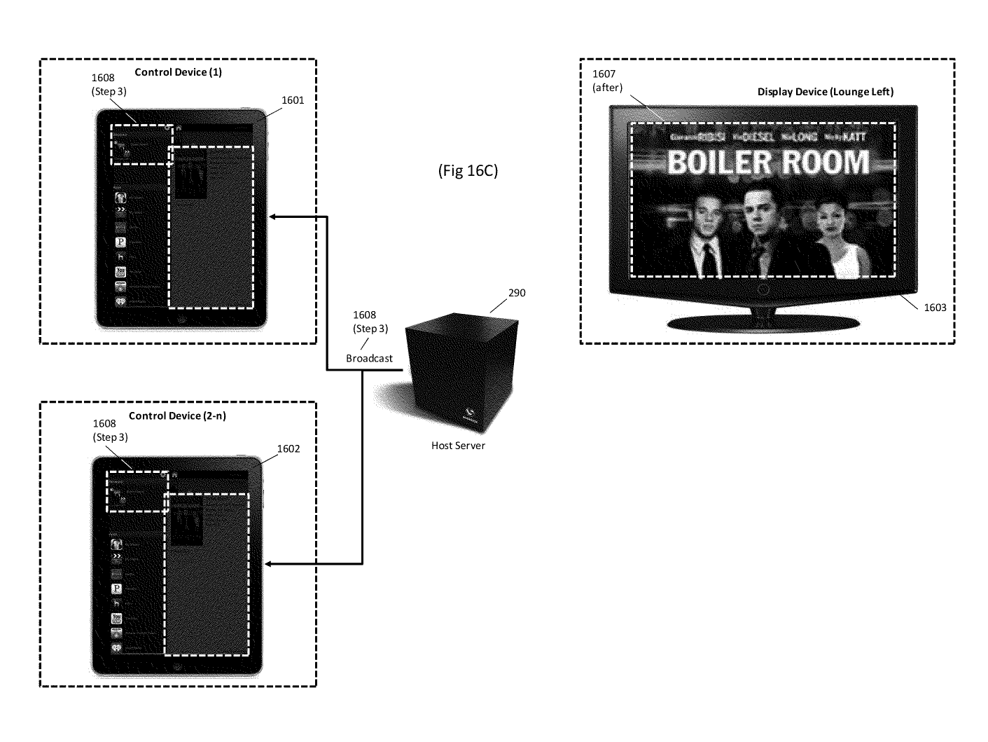

FIGS. 16A-16C exhibits the utilization of device native controls for heads-up and heads-down modes of operation by showing (FIG. 16A) before and (FIGS. 16B and 16C) after point-of-view from multiple control devices and an output display device for a video application type session. In this example, as shown in FIG. 16A in 1604 (step 1), the user seeks for and selects digital content from the available selectable video content list heads-down on control device 1 1601. This is translated into a request 1604 for the host server 290 to update the display device 1603 (Lounge Left) that is currently configured as the output device for the video application session. Further note that the “before” state 1606 of a secondary control device (2-n) 1602 which is not initiating the request 1604, but has an active control session connection to the host server 290. Next, in FIG. 16B the host server 290 responds in step 2 1607 and accordingly updates the viewable video content on the display device 1603 (Lounge Left) from what is previously depicted as “before” 1605 in FIG. 16B. Next, as shown in FIG. 16C, the host server 290 broadcasts the video application session state update to the control devices 1601, 1602 of which have an active control session connection to the host server 290. In this example, both control device 1 1601 and control devices 2-n 1602 as depicted in 1608 (step 3) receive the updated session state information for updating the interface heads-down view.

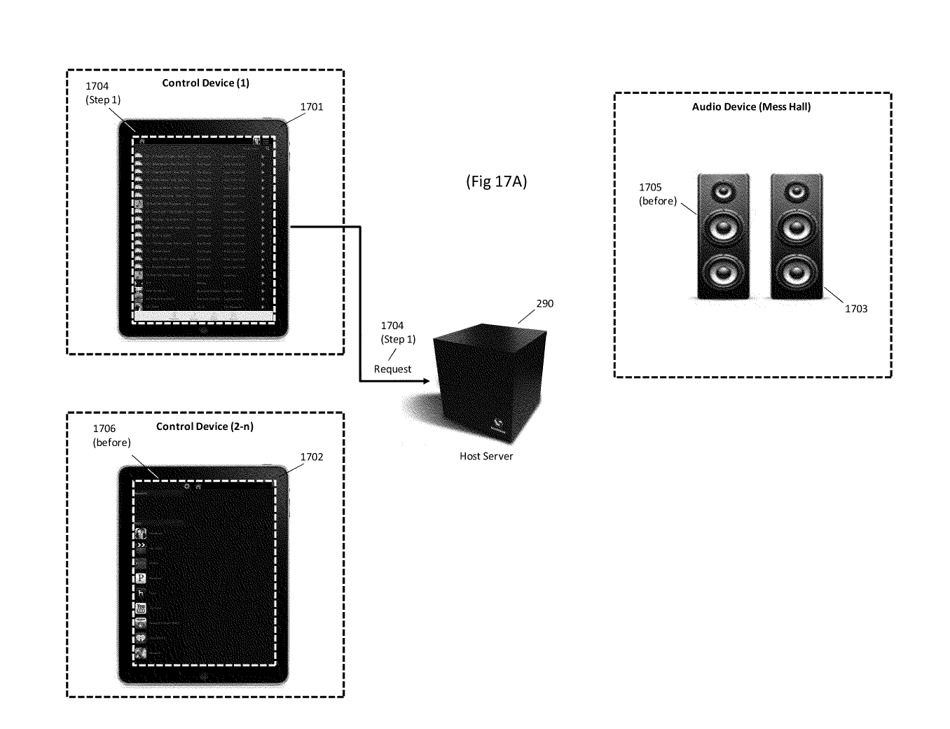

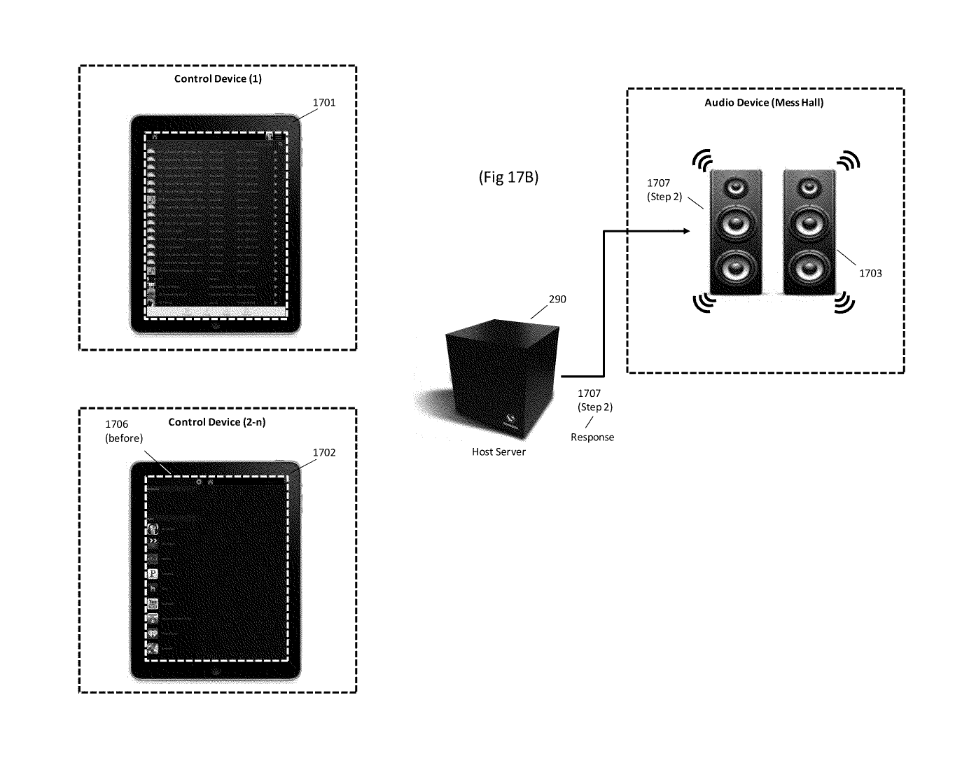

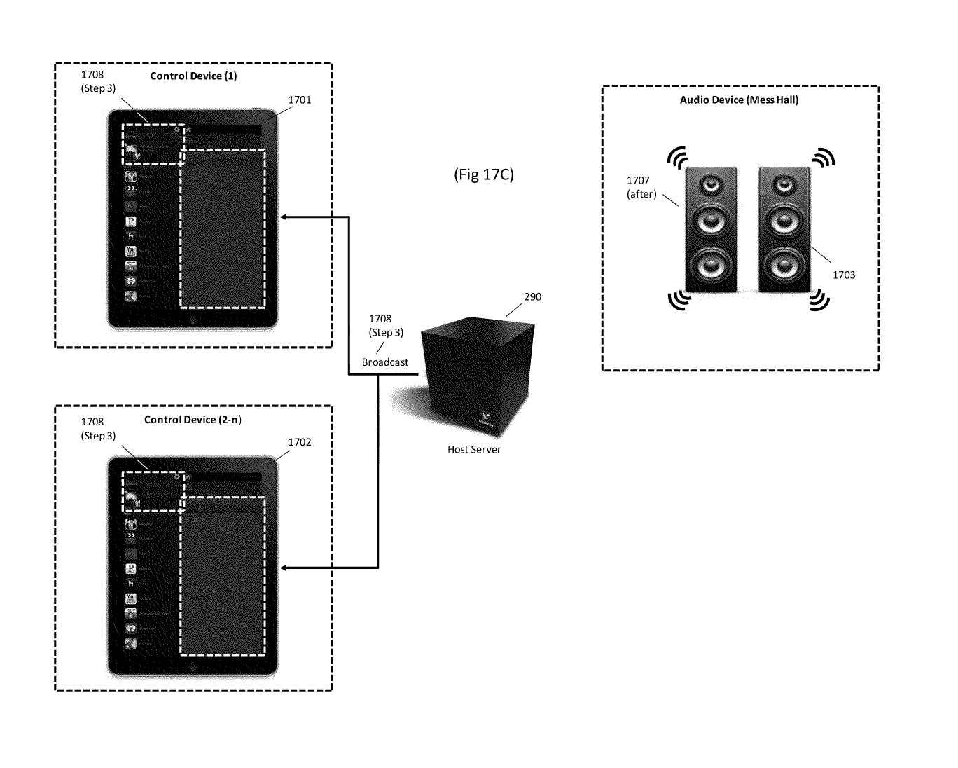

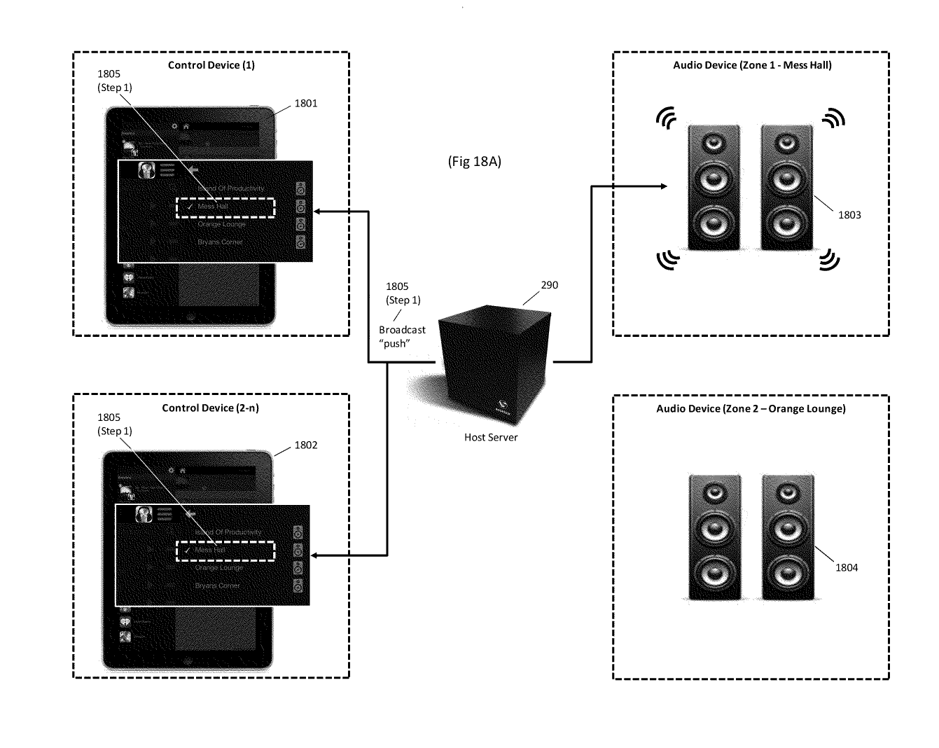

FIGS. 17A-17C exhibits the utilization of device native controls for heads-down and heads-up modes of operation by showing a before (FIG. 17A) and after (FIGS. 17B and 17C) point-of-view from multiple control devices and an output audio devices for an audio application session. In this example, as shown in FIG. 17A in 1704 (step 1), the user seeks for and selects content from the available audio content list heads-down mode on a control device 1 1701. This is translated into a request 1704 (step 1) to the host server 290 to update the audio device 1703 (Mess Hall) that is currently configured as the output device for the audio application session. Further note, the “before” state 1706 of the secondary control device 2-n 1702 which is not initiating the request 1704, but has an active control session connection. Next, in FIG. 17B the host server 290 responds in step 2 1707 and accordingly updates the audio content on the audio device 1703 from what is previously depicted as “before” 1705 in FIG. 17A. Also, as shown in FIG. 17C, the host server 290 broadcasts the audio application session state update to the any of the control devices that have an active control session connection to the host server. In this example, both control device 1 1701 and control devices 2-n 1702 as depicted in 1708 (step 3) receive the updated session state for updating the mobile device's heads-down view.

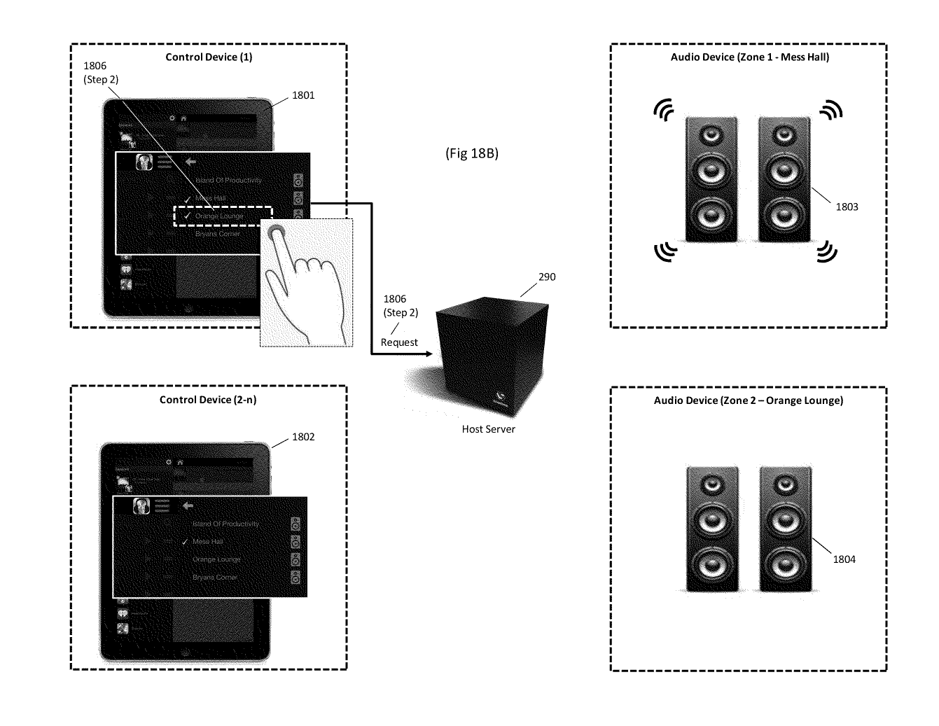

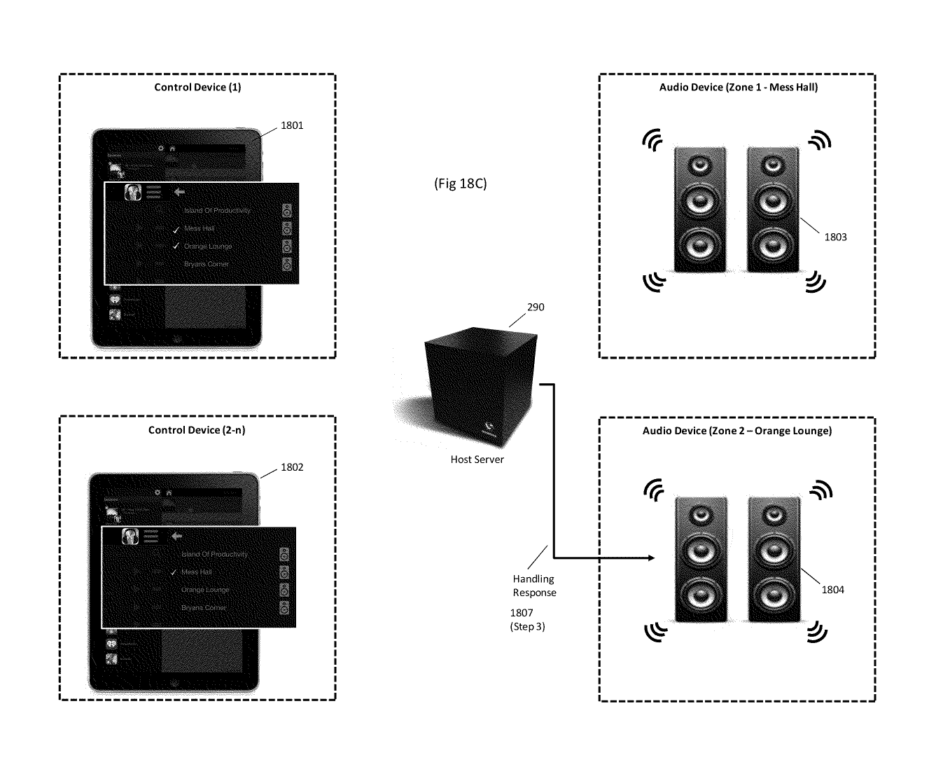

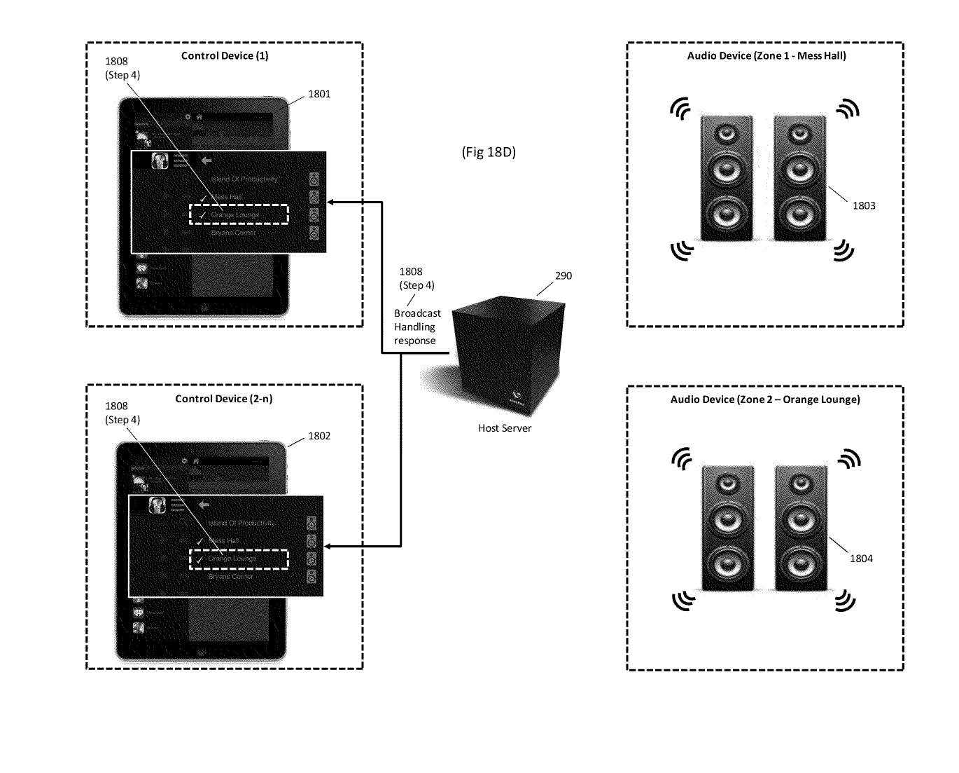

FIGS. 18A-18D exhibit the details (a novel use) of a preferred embodiment of a socket-enabled messaging library for packaging, parsing, sending, and receiving messages between a host server and control devices. In this example, control devices use a socket-enabled messaging library to request a host server to add an audio zone output to an active session (also referred to as “output device zone-switching”). The host server then informs all control devices that have an active control session connection to the host server of the updated session state, and the control devices update their interfaces accordingly.

In FIGS. 18Aa in 1805 (step 1), the host server 290 broadcasts the current session state information to all control devices that have an active control session connection to the host server, which, in this case, includes control device (1) 1801 and control devices (2-n) 1802. More specifically, the host server may have a client manager module 307 (as depicted in FIGS. 3, 4) with access to a socket-enabled messaging library. The host server active session may instruct the client manager 307 to send a broadcast message to all control devices with an active control session connection to the host server. The open socket utilization is preferable since a typical HTTP client-server utilization cannot “push” messages to a control device (client), rather only response messages are accepted by said clients. Further note that such a message is broadcast to all connected control devices 1801, 1802. In this example, the message information would include containing the current session state (e.g. “the session is playing audio only to the audio device (Zone 1—Mess Hall) 1803 and not audio device (Zone 2—Orange Lounge) 1804”).

In FIG. 18A, the control devices 1801, 1802 receive and parse respective messages containing session state information with a socket-enabled messaging library. Upon receiving the message, the control devices (clients) can handle the message by updating its user interface aesthetic, behavior, or underlying models. In FIG. 18A, the control devices 1801, 1802 update their viewable zone lists to indicate that the session is playing audio only to the audio device (e.g. Zone 1—Mess Hall) 1803 with a “check” mark, and not in audio device (Zone 2—Orange Lounge) 1804 as depicted in step 1 1805. In other examples, it could be the case that other control device (2-n) 1802 may choose to respond to identical messages in different ways, though in this example they do not (e.g. one control device could be in a video list mode (video application) and update its underlying zone modes without making any noticeable changes within its visual interface heads-down user point-of-view, while another control device interface is viewing the zone status and immediately sees the visual indication of the event). Now, the session state is visualized in the heads-down control device view on control devices 1801, 1802 by the Zone—1 Mess Hall 1803 element being the only zone that is checked off

As shown in FIG. 18B, the user of the heads-down on control device 1 1801, performs a finger “tap” gesture on the control device display, also checking off the “Orange Lounge” audio zone in step 2 1806 to add this zone as an audio output Zone—2 1804 for the current active session. Next, control device 1 1801, using an appropriate socket-based messaging library, encodes and sends the client initiated request message (step 2 1806) commanding the host server 290 to add the audio device Zone 2—Orange Lounge 1804 to the current active audio session. This message string encoded in a parsable format, such as JSON or XML, includes information (e.g. receiver identification, “add zone”) to execute the relevant arguments (e.g. Zone—2 Orange Lounge 1804), and sender identification in order to route responses. Note that such a message sent from any of the control devices 1801, 1802 would be handled identically by the host server 290, regardless of any particular control devices' current state (e.g. control device 1 1801 could be viewing a list of videos while any of the other control devices (2-n) 1802 could be switching audio zones).

As shown in FIG. 18C, once the host server 290 receives and parses the message string using its socket-based messaging library, the host server handles and responds to control device request 1806 (step 2) by switching (adding) the “Orange Lounge” zone to the current session as depicted in step 3 1807. Adding another zone implies a change in the heads-up output device, as well as other potential changes in the host server 290.

As shown in FIG. 18D, once the host server 290 receives and parses the message string using its socket-based library capability, as shown in FIG. 18D, next the host server 290 non-discriminately broadcasts a handling response message (step 4 1808) to all control devices 1801, 1802 with active control session connection indicating the change in session state. The new state informs control devices 1801, 1802 that the audio session is now additionally playing in two zones (1803, 1804), so failure to broadcast such a message would result in un-notified control devices incorrectly believing the session is still playing in a single zone. The broadcast handling response step 4 1808 ensures all of the said connected control devices 1801, 1802 are synchronized. As part of step 4 1808, control devices 1801 and 1802 receive the session status update message from the host server 290 and as handling response to said message, update their zone list “checks” via the user interfaces heads-down to indicate that the audio session is using both zone 1 1803 and zone 2 1804.

In general, a host server manages application sessions for non-discriminative control by one or more control devices that have access to said host; all accomplished via various application types each with potentially unique method flows of their own. Within these method flows are candidate examples where the host server manages the separation of content and control cognizant of the various application types the control devices non-discriminatively. Particular application types may include, but are not limited to, applications such as 1) a URL web browser, and 2) audio/video (from selectable content list information).

Generic description for all application types-Also, host server managed sessions may include the host server managing and communicating with the control devices. A client manager function of the server may communicate specifications related to the activated application sessions such as, but not limited to, permissions/access, unique identifier, and user profile. The host may communicate with one control device among a plurality of control devices. In addition to communicating specification of an application session, the host server communication may also include authorizing a control device to communicate with the host server in response to receiving an initialization request from any of the currently activated control devices. Such initialization request may be generated by a user action that may be performed in a heads-down mode via a device's native controls. The method also includes accepting a user's selection of any output devices that are shown as available in a heads-down control device screen. The user's selection may be based on at least the status information associated with the plurality of outputs connected to the network system. Further the method includes the host serving activated session content heads-up on the selected output devices (e.g. audio, video). Also, the method includes management of communication between control device and host server (over a network protocol including socket communication). The communication can be a request-response from the control device to host server, from host server to a control device, or a non-discriminative broadcast (“push”) communication from the host server to multiple control devices. Within the control device, messages containing session state or other information from a host server may trigger changes in control device user interface aesthetic, layout, or behavior. Within a host server, messages from a control device may trigger execution of any number of functions, including manipulations of any number of heads-up output devices (e.g. audio, video).

Additionally, cognizant of the browser application method flow, there is an inferred (or inherent) dependency from any the control devices with access to the session for the viewable selection content information heads-up on the selected output device need to be within the same proximity (zones) to one another as the user needs to be able to see the selectable content and the mouse-pointer (and associated movement) heads-up on said output device (display) for a meaningful user experience. Further, the method includes changing the presentation state heads-up in response to receiving a command from a control device and associated device native control gesture movements heads-down. Also, the method includes from said control device that within same proximity (zone) to said session output device and said selectable content items being displayed heads-up, as part of the device native controls and finger movement or gestures, the pointer in view is positioned heads-up over the selectable content of interest and upon control device (user) tap gesture to simulate a selection the host server translates the movement into a command to launch the URL link with the associated selectable content and refreshes the session presentation state to the output device accordingly.

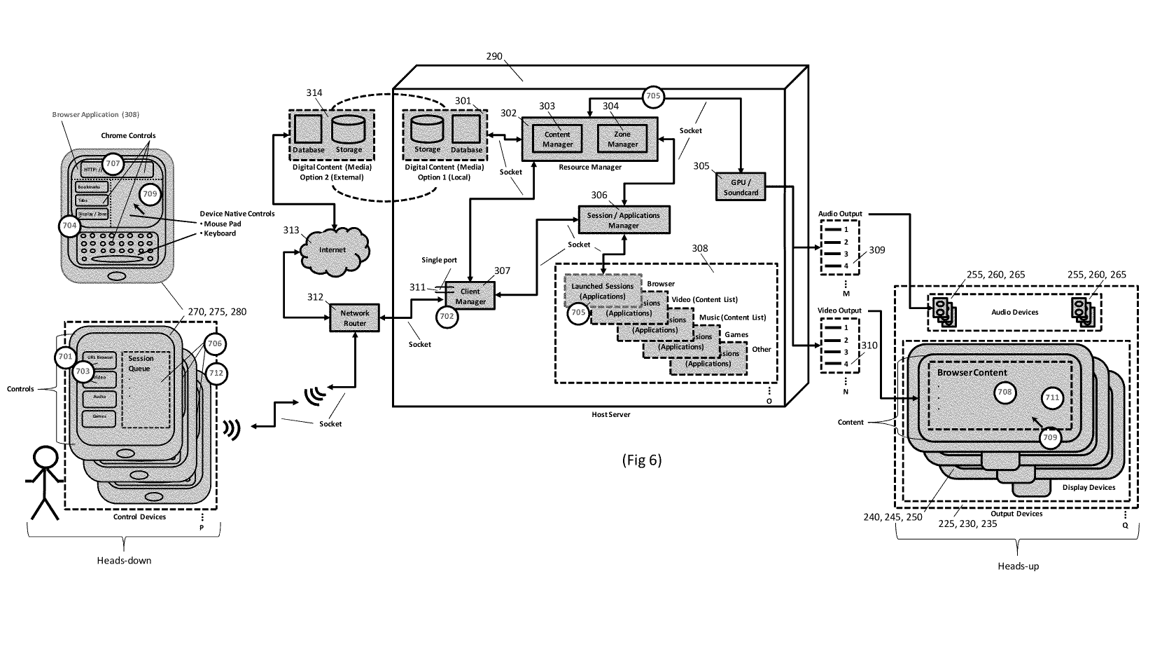

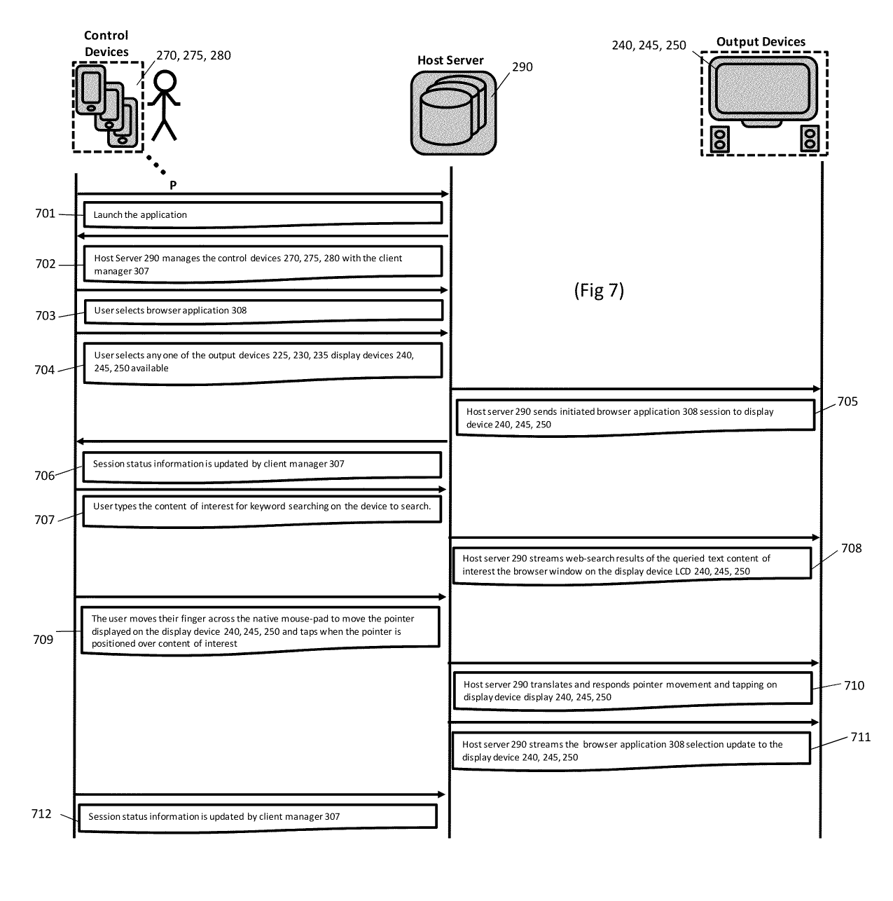

Both FIG. 6 and FIG. 7 represent a flow diagram and method flow for session application types 308 where host server 290 manages the separation of content (for heads-up display) and control (for heads-down display) via any of the control device 270, 275, 280 non-discriminatively to each other.

At 701, any one of the control devices 270, 275, 280 heads-down launches an access/login application for accessing the host server 290. Communications from a control device to a host server are generally referred and claimed herein as control data, including distribution control data, and the like.

At 702, in response to receiving the application initiation request from any one of the control devices 270, 275, 280 the host server's client manager 307 allows and manages access by the requesting control devices to the server via a socket-based inter-process communication (IPC) process. The host may also establish a control session that includes at least the control device form which the application initiation request is received. Additional control devices can also request to participate in any established control session to facilitate a plurality of control devices operating non-discriminatively to control the session. The additional control devices may be notified of the established control session in the session update that occurs in step 706 that is described below.

At 703, a user of the control device that initiated the access/login application of step 701 transmits distribution control data that may include information that represents a user's intention to select any of the application types 308 from a list of readily available application types in a heads-down mode on the control device. In the scenario of FIGS. 6 and 7, the user selects either of the browser applications 308, thereby marking the established control session as a browser application session.

In such a scenario, at 704, the user selects any of the output device display devices (LCD) 240, 245, 250 that are readily available and are within a home network system, such as home network system 200 that was established in FIG. 2. The user may use the control device to send distribution control data that may include the user's output device display device selection information to the host.

At 705, a host server-based session/application manager 306 and resource manager 302 respond to said request steps 703 and 704 by configuring the selected output device into the established session, thereby associating the at least one control device that initiated the session request and the selected output device into a control and content pair of devices. The host server further responses by transmitting data that facilitates display of a content window portion of the initiated browser application session to the previously selected output device display device (LCD) 240, 245, 250 of step 704. Note that in this browser application example embodiment the selected display device of step 704 may conveniently be in viewable proximity (zone) to the user so that viewable content (e.g. search results and other content list information) can be displayed heads-up for viewing and selecting by the control session requesting user via the user's control device. Information, such as information about a configuration of the home network may be available to the host server so that the host server can associate each output device display and/or each output device audio output to a proximal zone. IN an example, a television in a bedroom may be associated with a bedroom zone. In another example, a multi-media center in a lounge may be associated with a lounge zone, and the like. In this way, a control device may report its location in terms of a zone and then be more readily controlled based on this information. In an example, a control device that is initiating a request to establish and/or join an established control session may report its location as the lounge. The host may respond to this request based on the status of the output devices in the lounge. If the output devices in the lounge are currently allocated to established control zones, then the user's options may include joining existing sessions and/or being notified when an existing session is complete. If the output devices in the lounge are currently not allocated to established control zones, then the user may be invited to establish a control session for the lounge zone that includes the lounge output devices. These and other options are possible when zone-related information is used by the host server.

At 706, the host server's client manager 307 broadcasts the initiated session and all relevant status information to control devices 270, 275, 280 and any other control devices in the home network system 200 that have permission to access the host server 290. In this scenario, this session state information is sent to all of the control devices non-discriminatively. In this non-discriminative application type there is no need for the host server 290 to distinguish the control devices from each other. Also note that any of the control devices that are not in the same proximity (zone) to the requesting control devices (e.g. 270, 275, and 280) will not need to see the selectable content on the output display device. However, the session state information that the host server sends non-discriminately (agnostically) to all control devices can be viewed and displayed heads-down on each receiving control device. This session state information may be used, as noted above in step 702 by a control device user to decide to join an established control session. In an example of this use, a first user may receive a status update that a second user has established a control session to watch a movie in the lounge zone. The first user, may request to join this established session, even if the first user is not yet located within the lounge zone. Alternatively, a first user of a control device may have configured his preferences so that his control device automatically joins sessions that are established by certain other users based on the first user's location and/or control device status. In this way, when a first user is in the lounge, but is not currently joined the lounge control session and a friend enters the lounge and starts a control session for the lounge zone, the first user's control device may automatically join the established session in the lounge zone of the friend.

At 707, users of any of the control devices 270, 275, 280 that has permission and access to communicate to host server 290, can use the device native keyboard, mouse-pad (that may support gestures like pointer, pinch-to-zoom, finger scroll, etc.), and any other resident chrome controls that are in the appropriate allocated portion of the mobile device native user interface (e.g. a touch screen display) that is allocated to the browser application 308 currently being implemented to type or otherwise enter the content or URL of interest (e.g. in the appropriate space allocated for keyword searching on the device) to define search criteria. The control device may transmit control data that includes this search criteria or other user action to the host server.

At 708, in host server 290 the browser application 308, in association with the session/application manager 306 may access the previously initiated application session window of step 705 to conduct a web-search of the queried and requested content of interest from step 707. Content, found in response to step 708 web-searches may be sent to the browser window of the previously selected display device (LCD) 240, 245, 250 of step 704.

At 709, a user of any one of the control devices 270, 275, 280 that has permissions/access to communicate to host server 290 may be enabled to use control elements (e.g. chrome control effect movement of the content interaction indicator), such as, but not limited to, a pointer that is visible in the content displayed heads-up on the previously selected display device (LCD) 240, 245, 250 of step 704. Similarly, the user may tap the mouse pad when the pointer is positioned over the content of interest for selection.

At 710, in the host server 290 the session/application manager 306 translates the user content displayed heads-up on the previously selected display device (LCD) 240, 245, 250 of step 704. Similarly, the user may tap the mouse pad when they position the pointer over content displayed in the previously selected display device and taps on the content via device native interface, of control devices 270, 275, 280 of step 709, a URL at the selected pointer location is launched (e.g. by browser application 308 executing on the host server 290) and the resulting content may be displayed in the same display device LCD 240, 245, 250 of step 704.

At 711, the detail of the above mentioned launching of the selected URL is shown. The session/application manager 306 provides the browser application 308 with the selected URL for presenting on the previously selected display device LCD 240, 245, 250 in step 704 heads-up.

At 712, any of said control devices 270, 275, 280 that has permissions/access to communicate to host server 290 may receive all/updated session state information by the client manager 307 of the host server 290 including session state information such as zoning, URL string name, etc. Similar to the steps above, note that users of any control devices that are not in the viewable proximity (zone) of the display device may not be able to see the selectable content on the output display device; however they may receive the session state information that the host server sends non-discriminately (agnostically) to all control devices that have access to the host server.

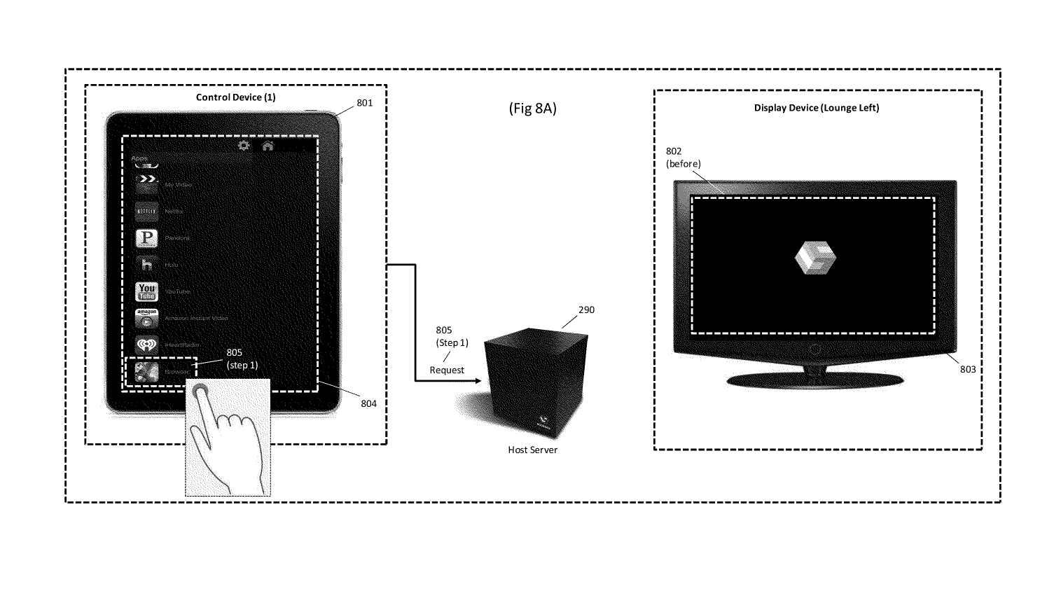

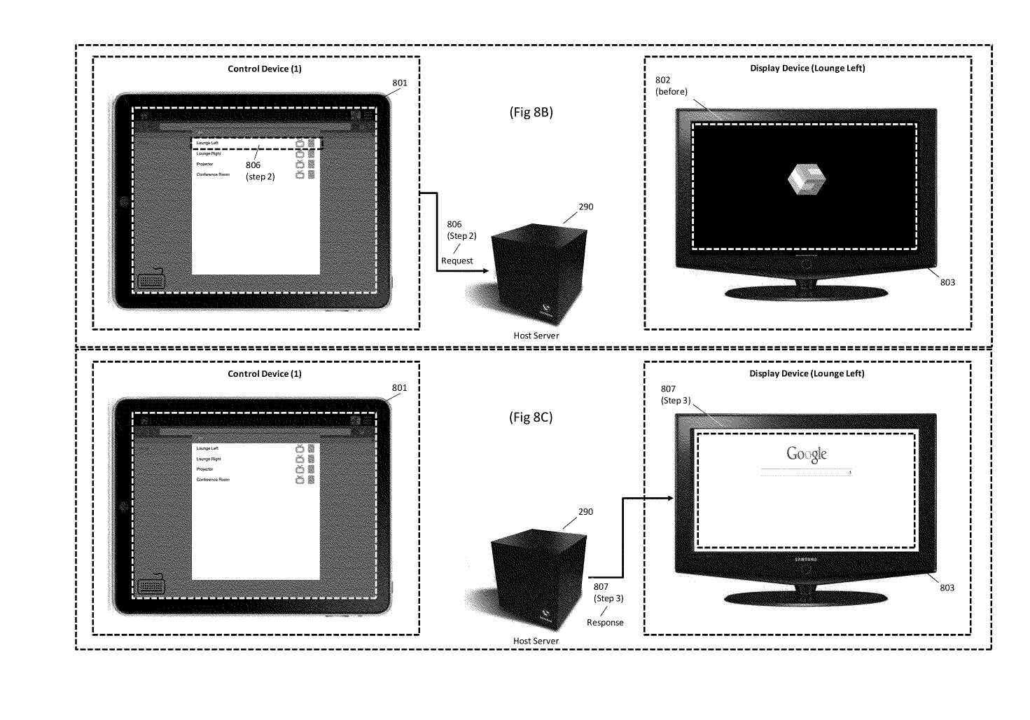

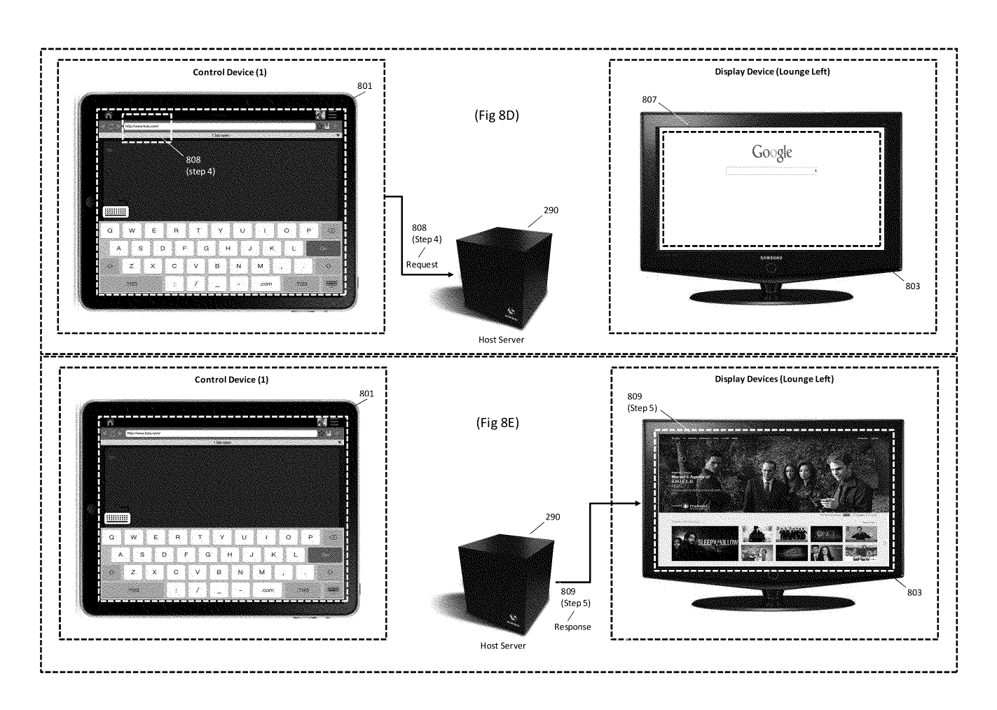

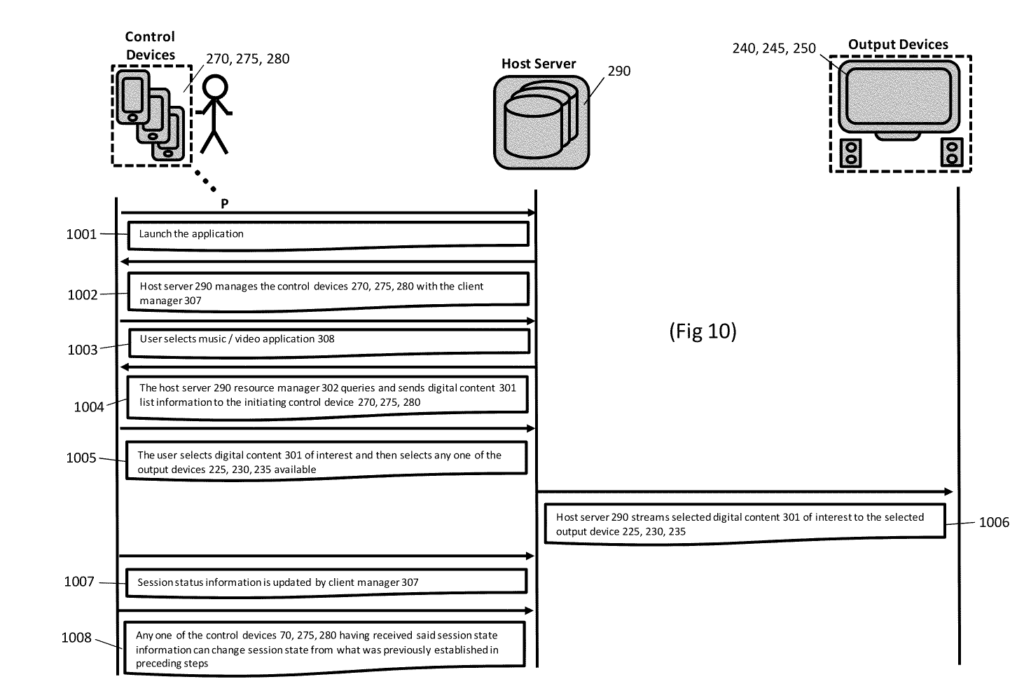

FIG. 8A-E further exhibits the represented flow diagram and method flow of FIG. 7 and FIG. 10 by showing the browser application session before and after point of view from the multiple control devices interface and the output display device. In this example, as shown in FIG. 8A in 805 (step 1), the user selects the browser application heads-down on a control device 1 801, which is translated into a request for the host server 290 to initiate said application session. Next, in FIG. 8B in 806 (step 2) the user selects heads-down from at least one of multiple selectable output devices available within the home network system which is translated and transmitted as a request to host server 290. In this example, the user has selected display device 803 (Lounge Left). Next, in FIG. 8C the host server 290 responds 807 (step 3) and accordingly updates the viewable browser window on the display device 803 from what is previously depicted as “before” 802 in FIG. 8B. Next, as shown in FIG. 8D in 808 (step 4), as part of the device native keyboard (resident chrome controls), the user types the content or URL of interest in the appropriate allocated portion of the control device 1 801 screen, which is translated into a request for the host server 290. Finally, in FIG. 8E in 809 (step 5), the host server 290 responds and accordingly updates the viewable browser window on the display device 803 from what was previously depicted in as “before” 807 in FIG. 8D.

Cognizant of the audio/video application method flow, there is less of a dependency from any of the control devices with access to the session for the selectable content list information heads-down (on said control device) needing to be within the same proximity (zones) to the selected output devices as the user can make a content item selection purely heads-down and the said output devices are only for streaming the selected digital content. Further, the method includes host server receiving a content item and output device (audio or video) selection request from any of the said control devices with access to the home network system. Also (as previously stated as above), the method includes broadcasting to any of the control devices session state information and/or associated digital content item selections heads-down both simultaneously and/or in a plurality of active sessions non-discriminately if there are more than one control devices receiving the broadcast.

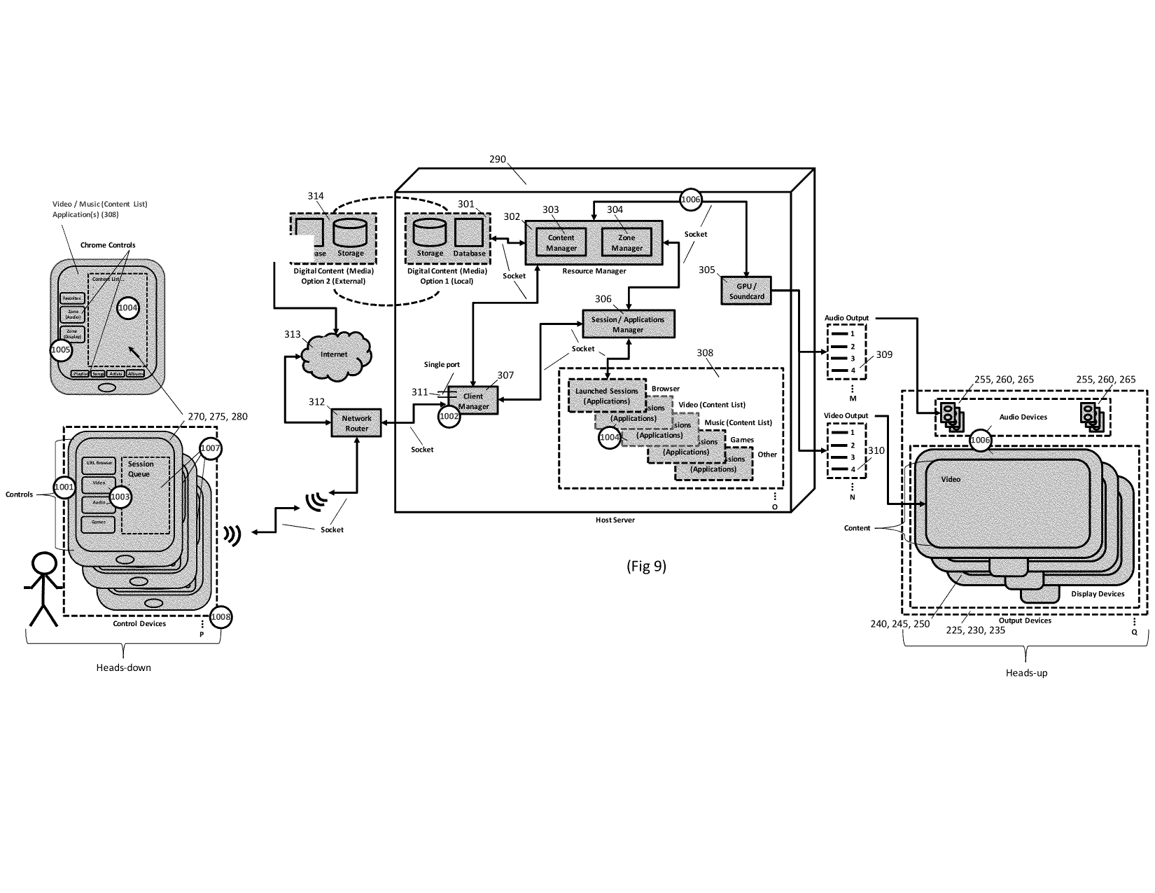

Both FIG. 9 and FIG. 10 represent a flow diagram and method for application type session where host server 290 manages the separation of content and control via any of the control device 270, 275, 280 non-discriminatively to each other.

At 1001, from any one of the control devices 270, 275, 280 that have permission/access to communicate to host server 290, a user launches the session control application to initiate access and communication to the host server 290. At 1002, in the host server 290 the client manager 307 manages the control devices 270, 275, 280 by consulting control device resources such as user profile, permissions, available applications, and zoning status (availability), etc. all of which is done through the utilization of sockets via inter-process communication (IPC).

At 1003, from any one of the control devices 270, 275, 280 communicating to host server 290 of step 1001, and within the launched application heads-down, the user can select either of the audio/video application types 308.

At 1004, in the host server 290, within the audio application 308 launched in the session applications manager 306, the resource manager 302 sends queries and sends the digital content 301 list information to the client manager 307, which in turn sends the digital content 301 list information to the any one of the control devices 270, 275, 280 of step 1001 that initiated audio 308 request as in step 1003 and then said digital content 301 list information is sent to the appropriate allocated portion of the display as part of the device native keyboard and resident chrome controls. Also, all session state information is updated simultaneously and multi-directionally by the client manager 307 of said host server 290 heads-down to any of the said control devices 270, 275, 280 such as, but not limited to session state information, such as zone availability in the active session queue.

At 1005, from any one of the control devices 270, 275, 280 that has permissions/access to communicate to the host server 290, heads-down the user selects said digital content 301 of interest that was provided by the host server 290 in step 1004 and then selects any one of the output devices 225, 230, 235 audio devices 255, 260, 265 and/or display devices LCD 240, 245, 250 readily available to send content search results based on the zoning status (availability) also established in step 1004.

At 1006, the resource manager 302 sends the initiated/selected audio/video application session digital content 301 to either of the selected audio devices 255, 260, 265 and/or display devices (LCD) 240, 245, 250 of step 1005. Note that any of the control devices that are not in the same proximity (zone) to each other will not need to see the selectable content on the output display device, but rather only the session state information of which the host server sends non-discriminately (agnostically) to all control devices that have access to the host server. Also, note that since said content list information is pushed agnostically to all of the control devices heads-down, any of the said control devices can actively contribute to content item list selections within any of the active sessions. This is a special embodiment (advantage) since none of the control devices are not dependent on the selectable content list items being displayed heads-up on any of the home network system output devices in the same proximity/zone as the controller as depicted in the previous method.

At step 1007, any of the control devices 270, 275, 280 that has permissions/access to communicate to said host server 290, all session state information is updated simultaneously and multi-directionally by the client manager 307 heads-down of the host server 290 to any of the said control devices 270, 275, 280, such as, but not limited, session state information including selected audio/video that is in the active session queue.

At 1008, for any one of the control devices 270, 275, 280 that has permissions/access to communicate to host server 290, having received said session state information that is currently and actively in the session queue of step 1007, can either 1) still repeat steps 1004-1006 if the user desires to select further digital content 301 concurrently and in addition to what is already in the session queue (e.g. opening another session in another zone, or adding to active session playlist), or 2) the user can alter active session states (e.g. delete, pause, rewind, etc.) that previously exists as established in steps 1004-1006. Note that in this method flow, the session state information is transmitted via host server 290 to any of the said control devices that have access to said host server agnostically non-discriminately to one another. Also, note that for any of the control devices 270, 275, 280 that has permissions/access to communicate to host server 290, can also intervene/change any existing session states that are currently and actively in the session queue since all content is heads-down on any of the control devices. Further note that in the cases where said digital content 301 in this method flow, where music is selected by any of the control devices 270, 275, 280, they can be decentralized from any of the said audio devices 225, 230, 235 location (zone) since the outputs are heard audibly and not reliant on the user of the control devices needs to be within closer proximity. Similarly, note that in the case where said digital content 301 in this method flow, where videos are selected and sent to any of the said display devices LCD 240, 245, 250, they are usually centralized to where the user of the control devices needing to be within closer proximity of said output devices in order view the displayed content.

One skilled in the art will realize the disclosure may be embodied in other specific forms without departing from the spirit or essential characteristics thereof. The foregoing embodiments are therefore to be considered in all respects illustrative rather than limiting of the disclosure described herein. Scope of the disclosure is thus indicated by the appended claims, rather than by the foregoing description, and all changes that come within the meaning and range of equivalency of the claims are therefore intended to be embraced therein.

Another example embodiment of the present disclosure includes a non-transitory computer readable medium having computer readable program codes embodied therein for managing and distributing digital content media and associated controls given the application type in a network system, the computer readable program codes including instructions that, when executed by a processor, cause the processor to receive a request from any one of a plurality of control devices to deliver at least one item of digital content either stored on or provided via Internet access of a host server through the network system from the host server. Further, the code causes the processor to uniquely identify and decide to discriminate between any of the plurality of control devices and similarly to any of the plurality of output devices when a given specific application types requires the host server to do so. Further, the code causes the processor to serve the at least one item of digital content and/or the session state information via the selected outputs in response to receiving the command from any one of the control devices. Similarly, given the specific application type the code causes the processor to either uniquely identify and include control and output device information in the session state information. Further note that said code may reside both on host server operating system and associated processor and additionally on the control device resident operating system and resident operating system and associated processor.

In addition, the code causes the processor to provide any one of the control devices with session state information associated with the digital content and session state information for a plurality of outputs of the host server connected to the network system in response to receiving the request. The code also causes the processor to receive a command from the any one of the control devices to serve the at least one item of digital content or the session state information associated with the digital content or the session state information for the plurality of outputs of the host server via a selected output, the selected output being selected by a user of any one of the plurality of control devices based on at least the session state information associated with the plurality of outputs connected to the network system. Further, the code causes the processor to serve the at least one item of digital content or the session state information via the selected outputs in response to receiving the command from any one of the control devices.

Further example embodiments of the present disclosure may be configured using a computer program product; for example, controls may be programmed in software for implementing example embodiments of the present disclosure. Further example embodiments of the present disclosure may include a non-transitory computer readable medium containing instruction that may be executed by a processor, and, when executed, because the processor to complete methods described herein. It should be understood that elements of the block and flow diagrams described herein may be implemented in software, hardware, firmware, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (RAM), read only memory (ROM), compact disk read only memory (CD-ROM), and so forth. In operation, a general purpose or application specific processor loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments of the disclosure.

Procedure or method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Computer program products suitable for embodying computer program instructions and data include all forms of non-volatile memory, including by way of example semiconductor memory devices. The computer program products can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques and approaches can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques and approaches can be implemented in a distributed computing system that includes a back-end component. The back-end component can, for example, be a data server, a middleware component, and/or an application server. The above described techniques and approaches can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and host servers. A client and a host server are generally remote from each other and typically interact through a communication network. The relationship of client and host server arises by virtue of computer programs running on the respective computers and having a client-host server relationship to each other.

Packet-based networks can include, for example, the Internet, a carrier Internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

Methods and systems of an audio/video distribution host interacting with a plurality of control devices that are treated as a single control device are described herein. A host server may facilitate distributing at least one video, audio, and content via at least one of an HDMI interface and an IP-based (e.g. Internet) interface to at least one audio/video output device during a control session. The host server may facilitate the distributing based on control inputs received from a plurality of instances of a mobile audio/video control application executing on a plurality of mobile devices. Each mobile device may use its native user interface to manipulate a content interaction indicator to facilitate interacting with visual content presented on the at least one audio/video output device. The mobile audio/video control applications may facilitate presentation of control elements associated with the control session on their respective mobile device. The mobile audio/video control application may also determine which user actions in the native user interface constitute control actions and which user actions in the native user interface constitute content manipulation actions. The control actions and the content manipulation actions may be communicated to the host server in such a way that the server can take appropriate action, such as updating the content interaction indicator.

The audio/video control application may determine which user actions in the native user interface constitute control actions and which user actions in the native user interface constitute content manipulation actions based on a context of at least one of the control session and the content. Alternatively, the mobile audio/video control application may receive content interaction indicator manipulation data from a second application (e.g. a web browser application) executing on the mobile device. The mobile audio/video control applications may facilitate presentation of control elements associated with the control session on their respective mobile device by indicating to the second application which items that the mobile audio/video control application passes to the second application are control elements. The audio/video control application may receive control elements for presentation to the user of the mobile device (e.g. through a web browser) from the host.

The control actions may result from user actions in the native user interface that manipulate the presented control elements.

Due to the host server's democratic treatment of all control application enabled mobile devices, the content interaction indicator may be capable of being manipulated by any of the plurality of control equipped mobile devices that are participating in the control session.

To facilitate updating users regarding important information about any control session in which the user is participating, the status of the control session is pushed from the host to each of the plurality of mobile devices in response to any of the plurality of mobile devices impacting the status.

While the content interaction indicator may most conventionally be depicted as a web browser-like pointer presented on the audio/video output device, it may alternatively be depicted as a change in visual representation of a content item based on a user content manipulation action. The content interaction indicator may also or alternatively include metadata associated with a content item that is presented on the audio/video output device. A content item may be any output of the host server other than session status and may include video output via the HDMI port or the IP port; audio output via the HDMI or audio port or the IP port; content and/or pointers to content that may be sent to the output device via the IP port.

In an alternate embodiment of the host server-based system for democratic control device participation in a content control session, the host server may communicate with the output devices via an IP protocol (e.g. via the Internet). Each control application enabled mobile device and each output device that participates in a control session may be identifiable by the host server. The user via the mobile control application may dictate output device participation in a control session.

Methods and systems of distributed content control may include heads-up content item selection by users of any of a plurality of control facilities that are treated as a single control facility when participating in an audio/video control session zone. Heads-up content item selection may include distributing video and/or audio to at least one audio/video output device in a control session zone. As noted above, the host server may distribute audio, video, and/or content items over dedicated outputs (e.g. HDMI) or via an IP-based network connection between the host server and the output device. The control and/or distribution of output may be based on user input from a plurality of audio/video control enabled mobile devices that each has a native user interface. The mobile devices may include smart phones, touch screen-enabled mobile devices, and the like. Heads-up content item selection may include displaying control data entered through the device native user interface on the mobile device, and displaying content items retrieved in response to the control data entry on the at least one audio/video output device. The content items displayed on the at least one audio/video output device may be selectable via the mobile device's native interface through a mobile audio/video application that communicates between the device's native interface and a host server that controls the presentation of the heads-up content to the output device. Manipulations of the native interface by the mobile device user can be interpreted to impact a content interaction indicator that the host presents on the heads-up content presented on the output device.

To facilitate heads-up content item display and selection on a control session zone-basis, a control session zone may be configured with at least one audio/video device and at least one mobile device so that content items displayed in such a control session zone are selectable only by mobile devices that participate in the control session zone even though many more control devices may be in communication with the host server.

Methods and systems of device non-discriminative heads-down content item selection in a native mobile device user interface that features control session status feedback from a control host server are also described herein. A host server may distribute video, audio, and/or IP-based content to at least one audio/video output device in a democratically managed multi-control device control session. The host server may provide video, audio and the like over dedicated output ports that connect to output devices (e.g. via HDMI). The host server may alternatively or in addition provide content that may include audio, video, web pages, and the like over an IP-compatible port (e.g. an Internet port) to IP-enabled output devices.

Host server distribution and output device interface actions may be based on user input from a plurality of remote audio/video enabled mobile devices via a native user interface of the mobile devices. Enabling a mobile device for such distribution control capabilities may include configuring the mobile device with an audio/video control application. Alternatively, a user may employ a basic web browser on a mobile device that communicates with control programs executing on a host server. User manipulation of the web browser (e.g. moving a pointer across a web page) via the native mobile device user interface may be interpreted by the host-based distribution control application and translated into appropriate actions, such as the host updating content displayed on one of the audio/video output devices.

In response to user interaction with mobile-device native user interface, content indicated by at least one content item presented in that user interface is displayed on the audio/video output devices. To facilitate keeping users updated regarding use of output display devices, control session status that identifies at least one mobile device distribution control action is pushed to the plurality mobile devices from the host server.

Methods and systems of host-based audio/video control zones are described herein. An audio/video distribution host server may be adapted for sending a plurality of audio and video signals through a plurality of independently controllable audio and HDMI outputs to a plurality of audio/video output devices as determined from control provided by a plurality of mobile control devices. The distribution host may establish a plurality of audio/video control zones that each comprises at least one audio/video output device, at least one mobile control device, and at least one audio/video signal. The audio/video distribution host may further facilitate user control of at least a portion of the at least one audio/video signal via user manipulation of a native user interface of a personal mobile device that is configured in the zone with an audio/video output device. In addition, the host server may push control session status that identifies at least one control device control action to the plurality of control devices.

A mobile control device may be configured with audio/video control software that enables access to a plurality of control zone sessions so that the mobile device user can participate in control sessions for more than one zone. This may be accomplished by multiple audio/video control applications executing on the mobile device. Alternatively, a user may select, within a particular audio/video control application, any of a plurality of control zones in which to participate.

An output device may be actively connected to a single control zone session. Once the output device is assigned to a particular control zone session, only mobile control devices that are also active in the particular control zone session may impact the display on the output device. Until the particular output device is removed from the control zone, only content that is flowing through the host server for the particular control zone will be displayed on the output device.

Alternatively, an output device can be divided among a plurality of zones, such as via a picture-in-picture function. In this way, a first portion of one output device can be controlled by a first session participants and a second portion of the output device can be controlled by a second session participants. Dividing an output device display into multiple zones may be useful for presenting a current program in a main portion of the display and allowing users that are configured in a second zone to display reviews of other programs to request for presenting in the main portion of the display. A second control session zone may be automatically configured to include all participants of a first control session zone when a user in the first session control zone activates a preview function as described herein. The second control session zone status and control information may be dynamically broadcast to all of the control devices in the first control session. In this way, users may continue to watch the first session content in the main portion of the display while participating in preview selection in the second control zone.

The methods and systems of host-based audio/video control zones may include a host server communicating content to IP-enabled output devices, such as smart displays and the like rather than through dedicated output ports, such as HDMI. Using IP-enabled output devices may reduce the cabling cost and complexity associated with dedicated host server to output device wiring. In addition, any IP-enabled output device may be utilized for such a zone session. In this way, a user may configure a control session zone with the user's mobile phone as a control device and the user's tablet as an output device. Ad-hoc control session zone setup flexibility that is afforded through use of IP-enabled output devices may benefit small group presentations, business meetings, and the like. A salesperson may bring a mobile phone and a tablet device to a sales call and setup a local control session zone with the two devices. The salesperson may grant participation access to other attendees of the sales call so as to facilitate attendee interaction with the content being presented on the tablet output device during the sales presentation. The automatic dual zone example described above may be useful in a sales call example in that a user may wish to review a portion of the presentation in a small portion of the display while the main sales material is presented in the main portion of the output device display. While a tablet is described in this example, any suitable IP enabled output device may be used, such as an IP-enabled projector, a video-conference system, and the like.

Methods and systems of non-discriminative content control with a host server may include establishing and maintaining multiple audio/video control sessions via a single host server. Each audio/video control session may be configured separately in a memory of the host server so that each control session can be independently configured, maintained, and operated. A host server may be configured with one or more resource manager facilities that may handle a plurality of zone definitions, and the like. The resource manager facilities may each control a single zone and/or may control a plurality of zones. In one embodiment, each time a session and/or zone is created; an instance of the resource manager is instantiated. In this embodiment, communication among all resource manager instances is enabled to facilitate coordination of use of output devices. In an embodiment that comprises a single resource manager, all output devices may be handled by the single resource manager function. Multiple sessions may be configurable through a session manager facility of the host server. Coordination of control device participation and output device use may be handled by the resource manager, client manager, and/or session/application manager.

Methods and systems of non-discriminative content control based on communication between a plurality of mobile devices and a host server may include placing content based on session context, such as heads-up and heads-down context of a session. In an example, dynamically determining a destination device for content items among a plurality of possible destination devices may be based on an audio/video control session context. In the example, determining a destination device may include sending first content to a heads-down display of a native user interface of an audio/video enabled mobile control device and sending second content to a heads-up display. In this example, the control device and the display are related through the audio/video control session. Examples of content to be sent to the heads-down display include: visual graphical control elements, chrome control elements, second content-specific selection data, heads-up content selection data, and the like. The second content-specific selection data may include a list of second content items.

In these methods and systems, a control session context may indicate which types of content should be directed to a heads-down operational device and which other types of content should be directed to a heads-up device. If a control session context identifies at least one control device but does not (yet) identify a heads-up device (e.g. a large screen display), then the context indicates that all content should be directed to the heads-down device. If a control session context also identifies a heads-up display that is participating in the control session, then control elements, such as chrome elements may be directed at the heads-down mobile device and web browser content, such as a web page content, may be directed at the heads-up display.

To the extent that content is directed through a host server to a control device, the host server may participate in the determination of which content is passed onto the control device based on the context of a control session for which the content is being handled. However, even if content is directed through a host server to the control device, an audio/video control application executing on the mobile device may determine which content to display on the mobile device native user interface (e.g. chrome control elements) and which to pass back to the host server to be presented on an output device display.

Although a decision regarding content destination may be made by an audio/video control application on a mobile device, content streams may be preconfigured by the host server to allow content to be delivered to both the control device and to the output device. The decision regarding which portion(s) of the content to display on the output device may be communicated from the control device, optionally through the host server, to the output device where a processor in the output device will implement the content decision. Likewise if the host server makes the decision regarding content destination, the host may direct such decision(s) to either or both of the control device and the output device for execution by the respective device processor.

Control session context may also indicate that control-related content is presented on the heads-down display, and content derived from the control-related content is presented on the heads-up display.

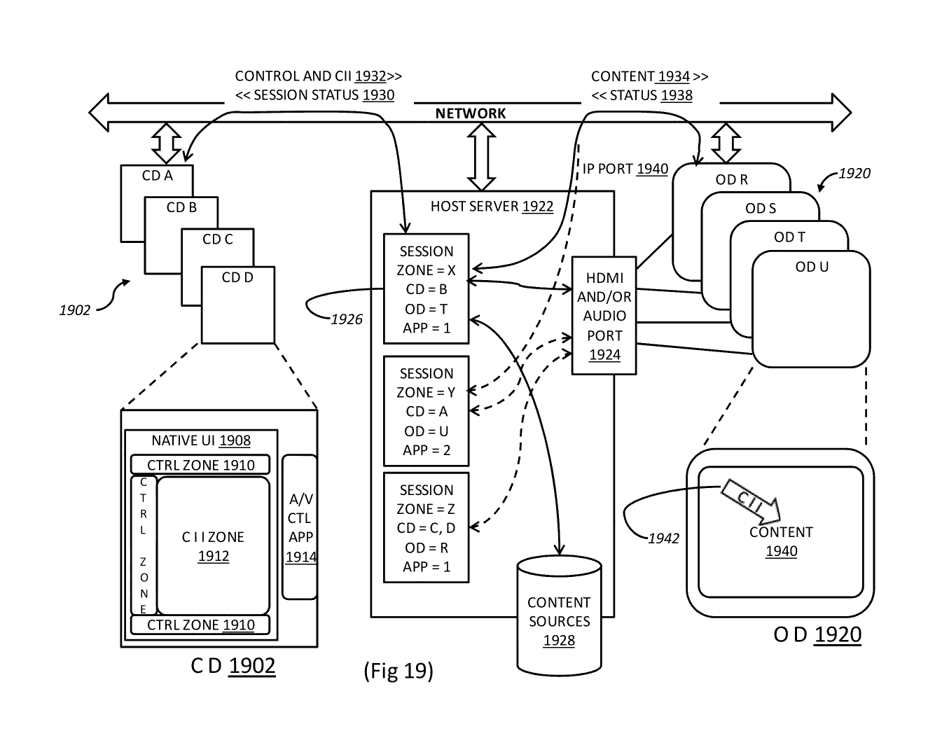

Referring to FIG. 19 that depicts a block diagram of an embodiment of a system for facilitating content control by a plurality of mobile devices interacting with a host server that provides content to discrete output devices, data and control flows are depicted. The system of FIG. 19 comprises a plurality of control devices (CD) 1902, a plurality of output devices (OD) 1920, a host server 1922, and content sources 1928.

A CD 1902 may include a native user interface 1908 that is both native to and supported by the basic functionality of the underlying device, such as a portable mobile phone and the like. The native user interface 1908 may comprise one or more control zones 1910 that may represent control elements, such as chrome control elements, visual control elements, and others as described herein and elsewhere, including control elements found in conventional web browsers (e.g. a search bar, address bar, favorites bar, and the like). The native user interface 1908 may also include a portion called a content interaction indicator zone 1912 that is configured for facilitating user control of a content interaction indicator as described herein. The control device 1902 may further include one or more audio/video control applications 1914 that may facilitate communicating between the native user interface 1908 and a host server 1922 for the purposes of controlling content selection, output, a/v session setup and operation, and the like. The a/v control app 1914 may facilitate receiving session status 1930 from a host server 1922 and delivering control and content interaction indicator actions 1932 to a session capability 1926 of the host server 1922.

A host server 1922 may comprise a variety of software programs, such as described herein including a session/application manager 306, launched sessions 308, client manager 307, and the like. Session zones 1926 of FIG. 19 may be similar to launched sessions 308 of FIG. 3 herein. A host server 1922 may also include a plurality of output ports, such as IP port 1940, HDMI and/or Audio port 1924, and the like. The host server 1922 may also include interfaces to content sources 1928 that may be resident or affiliated with host server 1922 or that may be unaffiliated third-party sources, such as Internet-based content providers and content storage systems. IP port 1940 may facilitate interfacing with output devices 1920 via a network, such as the internet, a local area network, a Wi-Fi network, a WAN, a cellular network, a mesh network, a virtual network, and the like. Although IP port 1940 is depicted in FIG. 19 for interfacing with OD 1920, it could be used to facilitate connecting the host server 1922 to any other IP connected device including CD 1902, other host servers, content sources 1928 and the like. HDMI and/or audio port 1924 may be described herein and elsewhere and may facilitate connection between the host server 1922 and any OD 1920 via dedicated interfaces such as HDMI, audio, and the like.

Session zones 1926 as exemplified in FIG. 19 may include a session context that may include a zone designator, one or more control device identifiers, one or more output device identifiers, session application identifier, and the like. Three session zones 1926 in FIG. 19 show various exemplary combinations of CDs, ODs, and applications. One such example session zone 1926 that depicts a control session with two control devices comprises a designator of “Z”; includes two control devices designated as “C” and “D”, an output device designated as “R”, and a session application designated as “1”. Each session zone 1926 may interface with content sources 1928, the IP port 1940, and the HDMI and/or audio port 1924. Further details of the structures, configuration, operation, and uses of session zones 1926 may be found elsewhere herein in association with figures and descriptions of the session manager 306, client manager 307, sessions 308, and the host server 290 generally.

Output devices 1920 depicted in FIG. 19 may include a plurality of audio, video, and IP-enabled devices that facilitate output to a user. A typical display type output device 1920 is depicted in FIG. 19 that includes a display of content 1940 that may be selected by a user via CD 1902, and a content interaction indicator 1942 that maybe manipulated by a user of a CD 1902 through interactions with CII zone 1912. Specific examples of such manipulations and the resulting impact on the CII 1942 are described elsewhere herein including FIGS. 12A-12B, 13A-13B, and 14A-14B.

A host server 1922 may interact with an OD 1920 via the IP port 1940 by delivering content 1934 and CII impact data to the OD while receiving OD status 1938 that the host server 1922 may use to operate control zones 1926 and the like.

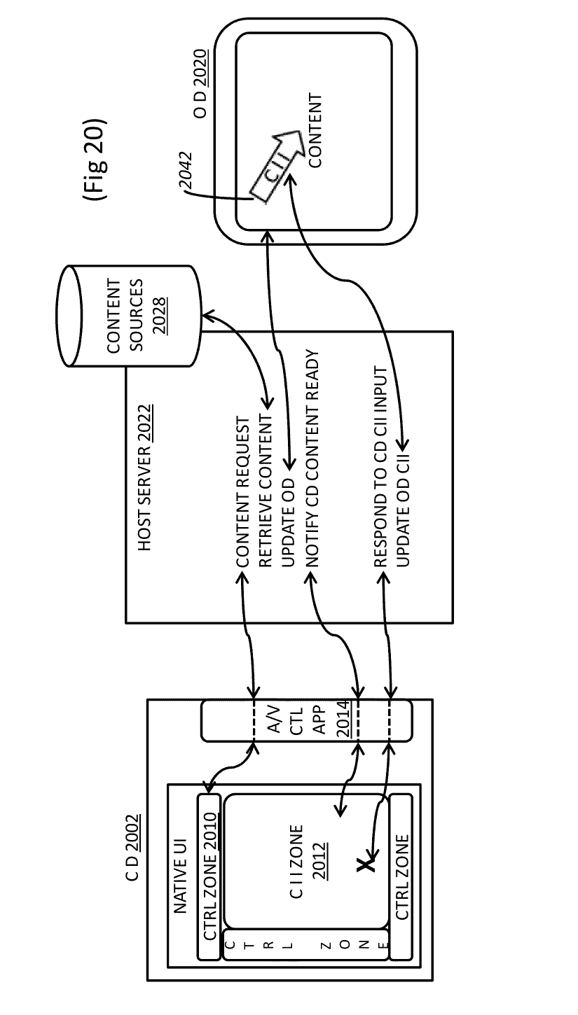

Referring to FIG. 20 that depicts interactions between a control device 2002 and a host server 2022 for controlling content with the CD 2002. Also depicted in FIG. 20 are interactions between the host server 2022 and output device 2020 for updating content and/or controlling content interaction indicator 2042.

User interactions via native user interface of the control device 2002 may include data entry or other actions in a control zone 2010. These actions may be processed through an audio/video control application 2014 and delivered to a host server 2022 as a content request. The host server 2022 may process the content request and retrieve content from one or more content sources 2028. A portion of the retrieve content may be provided by the host server 2022 to an output device 2020 to update content displayed on the output device via one or more of the ports supported by the host server 2022 as described in respect to host server 1922 of FIG. 19. The host server 2022 may provide a notification to control device 2002 when updated content is ready on OD 2020. This notification may be processed by a/v control app 2014 so that a CII zone 2012 portion of the native user interface may be configured to facilitate user manipulation of a CII 2042 that is presented on the OD 2020. In the example of FIG. 20, a user may select a position in CII zone 2012. This selection may be passed to a/v control app 2014 where it may be processed before being forwarded to the host server 2022. The host server 2022 may respond to the CII zone selection by updating the content interaction indicator 2042 on OD 2020.

Although a single control device 2002 is depicted in FIG. 20, any number of control devices 2002 may be actively interacting with the host server 2022. In a non-discriminative embodiment, each such control device 2002 may interact with the host server 2022 in ways similar to those shown in FIG. 20. When content has been updated on OD 2020, each such control device may be notified that the updated content is ready for user interaction via each device's CII zone 2012.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference

1. A method of distributing video and audio to at least one audio/video output device during a control session, comprising:
receiving distribution control data from at least one audio/video control application executing on a mobile device, wherein the distribution control data corresponds to user actions in a user interface native to the mobile device;
facilitating presentation of control elements associated with the control session on the mobile device based on a determination of which user actions in the native user interface constitute control actions and which user actions in the native user interface constitute content manipulation actions;
delivering content that is determined based on the received distribution control data for presentation through the at least one audio/video output device;
processing the received distribution control data to manipulate a content interaction indicator that is presented on the at least one audio/video output device; and
updating a plurality of audio/video control enabled mobile devices with control session metadata based on at least one of the delivered content and the distribution control data.

2-8. (canceled)

9. The method of claim 1, wherein the audio/video control application is one of a plurality of instances of the mobile audio/video control application executing on a plurality of mobile devices.

10. (canceled)

11. The method of claim 1, wherein status of the control session is pushed from the host to each of the plurality of mobile devices in response to any of the plurality of mobile devices impacting the status.

12. (canceled)

13. The method of claim 1, wherein the content interaction indicator comprises a change in visual representation of a content item based on a user content manipulation action.

14. (canceled)

15. The method of claim 1, wherein presenting content that is determined based on the received distribution control data on the at least one audio/video output device comprises transmitting at least one of an HDMI signal and an audio signal via a corresponding output port of a host server to a corresponding input port of the at least one audio/video output device.

16. A method of distributing video and audio over a network to at least one audio/video output-capable device during a control session, comprising:
receiving distribution control data over the network from at least one audio/video control application executing on a mobile device, wherein the distribution control data corresponds to user actions in a user interface native to the mobile device;
facilitating presentation of control elements associated with the control session on the mobile device based on a determination of which user actions in the native user interface constitute control actions and which user actions in the native user interface constitute content manipulation actions;
delivering content that is determined based on the received distribution control data over the network to the at least one audio/video output device;
processing the received distribution control data to facilitate manipulating a content interaction indicator that is presented on the at least one audio/video output device; and
updating a plurality of audio/video control enabled mobile devices via the network with control session metadata based on at least one of the delivered content and the distribution control data.

17. The method of claim 16, wherein the content interaction indicator facilitates interacting with content presented on the at least one audio/video output device.

18. The method of claim 16, wherein the plurality of audio/video control enabled mobile devices each execute an instance of the audio/video control application.

19. The method of claim 16, wherein distributing is based on the received distribution control data.

20. The method of claim 16, wherein the audio/video control application determines which user actions in the native user interface constitute control actions and which user actions in the native user interface constitute content manipulation actions.

21. The method of claim 20, wherein determining if a user action in the native user interface is for control or content manipulation is based on a context of at least one of the control session and the content.

22. The method of claim 16, wherein the audio/video control application receives data representing control elements for presentation of graphical control elements to the user.

23. The method of claim 16, wherein control actions result from user actions that manipulate the presented control elements.

24. The method of claim 16, wherein the audio/video control application is one of a plurality of instances of the mobile audio/video control application executing on a plurality of mobile devices.

25. (canceled)

26. The method of claim 16, wherein status of the control session is pushed from the host to each of the plurality of mobile devices in response to any of the plurality of mobile devices impacting the status.

27. The method of claim 16, wherein the content interaction indicator comprises a web browser-like pointer presented on the audio/video output device.

28. The method of claim 16, wherein the content interaction indicator comprises a change in visual representation of a content item based on a user content manipulation action.

29. The method of claim 16, wherein the content interaction indicator comprises metadata associated with a content item presented on the audio/video output device.

30. The method of claim 16, wherein the network is a personal network configured in a user's residence.

31. A system for distributing video and audio over a network during a content distribution control session, comprising:
an audio/video control application executing on a mobile device for preparing distribution control data that corresponds to user actions in a user interface native to the mobile device;
a host server that receives and processes the distribution control data that is prepared by the a/v control application, wherein the host server comprises a plurality of audio and/or video output ports adapted to provide output to at least one audio/video output device and at least one facility for accessing a plurality of content sources; and
at least one content interaction indicator adapted for presentation on the at least one audio/video output device that visually depicts user actions in a content interaction indicator portion of the user interface of the mobile device.

32-109. (canceled)
